(19) United States
(12) Patent Application Publication
(10) Pub. No.: US 2007/0071956 A1
(43) Pub. Date: Mar. 29, 2007

(54) Process for the production of glass shaped material, crystallized glass material, process for the production of crystallized glass material, process for the production of magnetic disk substrate blank, process for the production of magnetic disk substrate and process for the production of magnetic disk

(75) Inventor: Xuelu Zou, Tokyo (JP)

Correspondence Address: NIXON & VANDERHYE, PC, 901 NORTH GLEBE ROAD, 11TH FLOOR, ARLINGTON, VA, 22203, US

(73) Assignee: HOYA CORPORATION, Tokyo (JP)

(21) Appl. No.: 11/524,532

(22) Filed: Sep. 21, 2006

(30) Foreign Application Priority Data
Sep. 27, 2005 (JP) 2005-280536
Sep. 28, 2005 (JP) 2005-282681

(51) Int. Cl. B32B 27/32; C03C 10/00; C03C 10/10

(52) U.S. Cl. 428/220; 65/33.9; 65/33.7; 65/33.1; 65/126; 65/66

(57) ABSTRACT

A process for stably producing a glass shaped material as a base material for a crystallized glass material, which includes casting a molten glass into a through hole of a mold, the through hole having a straight central axis, said central axis being vertical or slanted relative to a horizontal, and shaping the molten glass into a rod-like glass shaped material as a base material for a crystallized glass material.

### FIELD OF THE INVENTION

The present invention relates to a process for stably producing a glass shaped material as a base material for a crystallized glass material, a crystallized glass material, a process for the production of a crystallized glass material, a process for the production of a magnetic disk substrate blank by slicing the above glass shaped material or crystallized glass material, a process for the production of a magnetic disk substrate by polishing the main surface of the above magnetic disk substrate blank and a process for the production of a magnetic disk by forming a magnetic recording layer on the above magnetic disk substrate.

### BACKGROUND ART

A magnetic disk that is also called a hard disk is an indispensable part for a personal computer, a memory of a mobile device, etc., and glass or aluminum is used as a substrate material for such a magnetic disk at present. As a substrate material for a next-generation magnetic disk, a crystallized glass is promising as is described in JP-A-2001-180975.

### DISCLOSURE OF THE INVENTION

### Problems to be Solved by the Invention

An aluminum substrate having low heat resistance has a problem that the substrate is thermally deformed during heat treatment or under a use environment at high temperatures.

In contrast, a substrate formed of a crystallized glass has sufficient mechanical strength even when its thickness is decreased, and it has high rigidity. Further, it is excellent in stability during high-speed rotation and also excellent in heat resistance. Therefore, the formation of a film such as a magnetic recording layer and the heat treatment of a formed film can be carried out at high temperatures. However, a crystallized glass that is excellent as a substrate material as described above has the following problems.

When a crystallized glass material is produced, first, an amorphous glass shaped material is prepared and it is required to apply precise heat treatment to the amorphous glass shaped material in order to disperse and precipitate a fine crystal phase. A crystal that precipitates before the above heat treatment is that which is accidentally generated without controlling the conditions of temperature, etc., and the crystal may be coarse or the dispersion or precipitation of a crystal phase may be non-uniform, so that a resultant crystallized glass cannot be used for a magnetic disk substrate. It is hence required to keep a crystal from precipitating in the amorphous glass shaped material before the above heat treatment.

Since, however, the composition of the glass constituting the amorphous glass shaped material as a base material for a crystallized glass material is determined such that a predetermined crystal phase is easily precipitated by the heat treatment, the above glass has the property of undergoing easy precipitation of a crystal in the process of producing the amorphous glass shaped material.

It is therefore difficult to produce an amorphous glass shaped material as a material for a crystallized glass material at high yields while suppressing the precipitation of a crystal.

On the other hand, as a method for the production of a substrate formed of the above crystallized glass, there can be a method in which a columnar glass shaped material is crystallized, sliced and polished to produce a disk-like crystallized glass substrate. Further, it is thinkable that the mass productivity thereof is improved by stacking a plurality of columnar crystallized glass materials having equal outer diameters such that they are aligned in the longitudinal direction and slicing them at the same time since many crystallized glass substrates can be obtained by one operation of the slicing.

According to studies made by the present inventor, however, it has been found that when a plurality of columnar crystallized glass materials having equal outer diameters are stacked such that they are aligned in the longitudinal direction and sliced at the same time, the resultant disk-like substrates are sometimes non-uniform in thickness or sometimes have poor roundness.

The present invention has been made for overcoming the above problems. It is an object of the present invention to provide a process for stably producing a glass shaped material as a base material for a crystallized glass material, a crystallized glass material having a columnar form in which a plurality of such crystallized glass materials can be highly accurately sliced when they are stacked such that they are aligned in the longitudinal direction, a process for the production of a crystallized glass material, a process for the production of a magnetic disk substrate blank by slicing the above glass shaped material or crystallized glass material, a process for the production of a magnetic disk substrate by polishing the main surface of the above magnetic disk substrate blank and a process for the production of a magnetic disk by forming a magnetic recording layer on the above magnetic disk substrate.

### Means to Solve the Problems

For achieving the above object, the present inventor has made diligent studies and found that a rod-like glass shaped material can be stably produced by arranging a mold having a through hole with a straight central axis such that the above central axis is vertical or slanted relative to a horizontal and causing a molten glass to flow into the above through hole. It is also found that when a crystallized glass having a columnar form and having a predetermined value or less of an outer diameter tolerance and a predetermined value or less of a straightness is used, disk-like substrates obtained are not non-uniform in thickness and they are free from a decrease in roundness. The present invention has been completed on the basis of the finding of these.

That is, the present invention provides

(1) a process for the production of a glass shaped material, which comprises

casting a molten glass into a through hole of a mold, the through hole having a straight central axis, said central axis being vertical or slanted relative to a horizontal, and

shaping the molten glass into a rod-like glass shaped material as a base material for a crystallized glass material,

(2) a process for the production of a glass shaped material as recited in the above (1), wherein said glass comprises TiO₂, SiO₂ and MgO and has an SiO₂/MgO molar ratio of from 0.8 to 6.0,

(3) a process for the production of a glass shaped material as recited in the above (1), wherein said glass comprises, by mol %, 35 to 65% of SiO₂, over 5% to 20% of Al₂O₃, 10 to 40% of MgO and 5 to 15% of TiO₂, the total content of SiO₂, Al₂O₃, MgO and TiO₂ is 92% or more and the SiO₂/MgO molar ratio is from 0.8 to 6.0,

(4) a process for the production of a glass shaped material as recited in any one of the above (1) to (3), wherein a circumferential surface of the glass shaped material is further machined to obtain a columnar form,

(5) a crystallized glass material that is obtained by heat-treatment of a glass shaped material and has a columnar form having a length of L (mm), an outer diameter tolerance of ±0.2 mm or smaller and a straightness of 5×10⁻⁵×L (mm) or less,

(6) a crystallized glass material as recited in the above (5), which contains enstatite and/or an enstatite solid solution as a crystal phase,

(7) a crystallized glass material as recited in the above (5) or (6), which has a length L of 100 mm or more and an outer diameter of 16 to 70 mm,

(8) a crystallized glass material as recited in any one of the above (5) to (7), whose circumferential surface has an average roughness Ra of 0.3 μm or less,

(9) a crystallized glass material as recited in any one of the above (5) to (8), which is a base material for a magnetic disk substrate,

(10) a process for the production of a crystallized glass material, which comprises thermally treating a glass shaped material produced by the process recited in any one of the above (1) to (4) to obtain a crystallized glass material having a crystal phase precipitated in the entirety of a use region,

(11) a process for the production of a crystallized glass material as recited in the above (10), wherein the glass shaped material having a columnar form is heated for crystallization while the glass shaped material is rotated in the circumferential direction about the central axis of the columnar form,

(12) a process for the production of a crystallized glass material as recited in the above (11), wherein the crystallized glass material obtained is a crystallized glass material that is obtained by the heat-treatment of the glass shaped material and has a columnar form having a length L (mm), an outer diameter tolerance of ±0.2 mm or smaller and a straightness of 5×10⁻⁵×L (mm) or less,

(13) a process for the production of a magnetic disk substrate blank, which comprises slicing a glass shaped material produced by the process recited in any one of the above (1) to (4) perpendicular to the longitudinal direction of said glass shaped material and then thermally treating a sliced glass piece to obtain a magnetic disk substrate blank having a crystal phase precipitated in the entirety of a use region,

(14) a process for the production of a magnetic disk substrate blank, which comprises slicing the crystallized glass material recited in the above (5) perpendicular to the longitudinal direction of the crystallized glass material,

(15) a process for the production of a magnetic disk substrate blank, which comprises slicing the crystallized glass material produced by the process recited in the above (10) perpendicular to the longitudinal direction of the crystallized glass material,

(16) a process for the production of a magnetic disk substrate, which comprises polishing a main surface of a magnetic disk substrate blank produced by the process recited in any one of the above (13) to (15), and

(17) a process for the production of a magnetic disk, which comprises forming a magnetic recording layer on a magnetic disk substrate produced by the process recited in the above (16).

### EFFECT OF THE INVENTION

According to the present invention, there can be provided a process for stably producing a glass shaped material as a base material for a crystallized glass material, a crystallized glass material having a columnar form in which a plurality of such crystallized glass materials can be highly accurately sliced when they are stacked such that they are aligned in the longitudinal direction, a process for the production of a crystallized glass material, a process for the production of a magnetic disk substrate blank by slicing the above glass shaped material or crystallized glass material, a process for the production of a magnetic disk substrate by polishing the main surface of the above magnetic disk substrate blank and a process for the production of a magnetic disk by forming a magnetic recording layer on the above magnetic disk substrate.

### BRIEF DESCRIPTION OF THE DRAWINGS

FIG. 1 is a schematic drawing that shows an example of an apparatus for producing a glass shaped material.

FIG. 2 is a schematic drawing that shows an example of an apparatus for producing a glass shaped material.

FIG. 3 is a schematic drawing that shows an example of a method for splitting a glass shaped material.

FIG. 4 is a schematic drawing that shows an example of a method for splitting a glass shaped material.

FIG. 5 is a schematic drawing that shows an example of a method for splitting a glass shaped material.

FIG. 6 is a schematic drawing that shows an example of a method for splitting a glass shaped material.

FIG. 7 is a schematic drawing that shows an example of a method for splitting a glass shaped material.

FIG. 8 is a schematic drawing that shows an example of a method in which a plurality of columnar glass materials are sliced while they are stacked such that they are aligned in the longitudinal direction.

In Figures, numeral 1 indicates a pipe, 2 indicates a molten glass, 3 indicates a mold, 4 indicates a glass shaped material, 5 indicates rollers, 6 indicates a circumferential surface of a glass shaped material, 7 indicates a shaping furnace, 8 indicates a liquid level sensor, 9 indicates a controller, 10 indicates a support mechanism, 11 indicates a glass shaped material, 12 indicates a high-pressure vessel and 13 indicates a liquid introduction port.

### PREFERRED EMBODIMENTS OF THE INVENTION

[Process for the Production of Glass Shaped Material]

The process for the production of a glass shaped material, provided by the present invention, comprises

casting a molten glass into a through hole of a mold, the through hole having a straight central axis, said central axis being vertical or slanted relative to a horizontal, and

shaping the molten glass into a rod-like glass shaped material as a base material for a crystallized glass material.

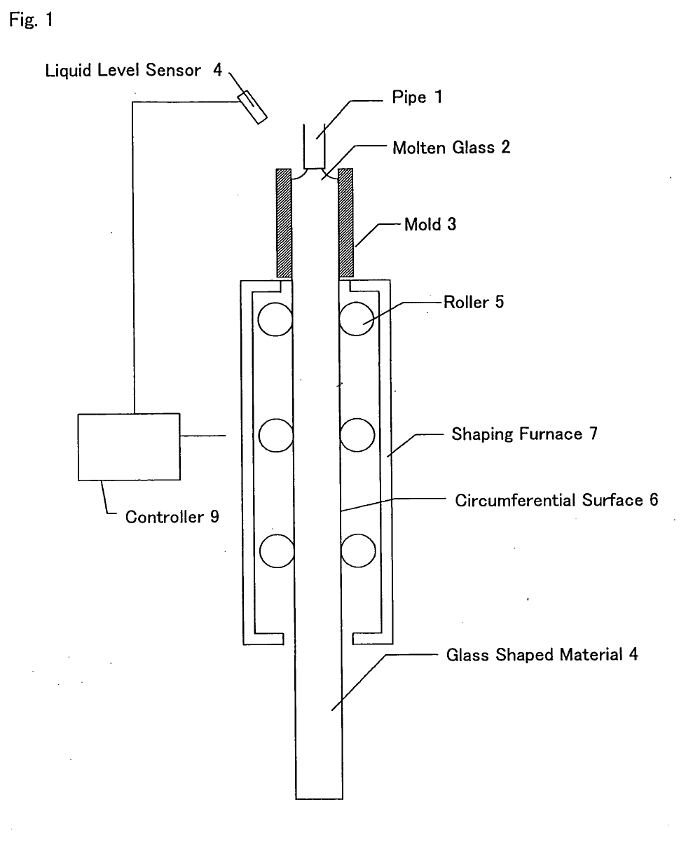

The process for the production of a glass shaped material, provided by the present invention, will be specifically explained below with reference to FIGS. 1 to 6.

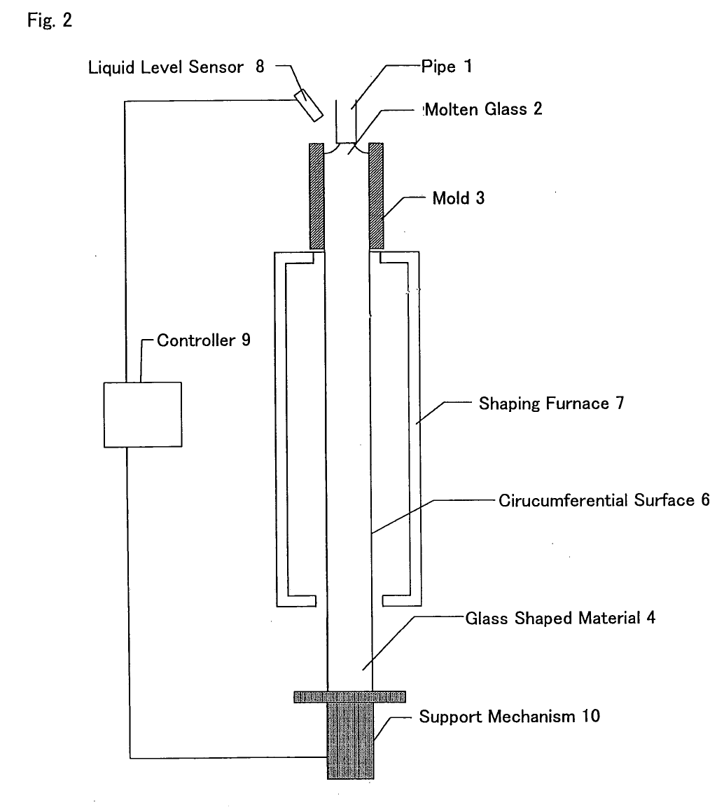

The glass shaped material is preferably produced as shown in FIG. 1 or 2, in which a mold 3 having a columnar form and having a through hole with a straight central axis is arranged such that the above central axis is in the vertical direction and a molten glass 2 is caused to flow from a lower portion of a pipe 1 into the above through hole to fill molten glass in the mold 3.

The longitudinal direction of the pipe 1 is preferably vertical as shown in FIG. 1 or 2, and in this arrangement of the pipe 1, the turbulence of the glass flow in the mold, which will be discussed later, can be decreased.

The central axis of the through hole of the mold 3 is straight. While the form of the through hole is not specially limited, the through hole preferably has a cross-sectional form taken at right angles with the moving direction of a glass which cross-sectional form is the same in any position so that the movement of the glass is not hampered, and the form of the through hole includes the form of a cylinder, and the cross-sectional form includes a circle, an ellipsoid or a polygon. When the temperature distribution of the mold 3 is not controlled, the cross-sectional form of the through hole changes due to the thermal expansion of the mold 3 since the inlet side of the mold 3 has a higher temperature than the outlet side thereof, so that even if the cross-sectional form of the through hole at the right angles of the moving direction of the glass is constant in any position before shaping of a glass, the cross-sectional form of inlet side of the through hole and the cross-sectional form of outlet side thereof come to be different from each other during the shaping of a glass. In the process for the production of a glass shaped material, provided by the present invention, therefore, the form of the through hole before the shaping of a glass is preferably a form in which the cross-sectional area of the through hole increases from the inlet to the outlet of the through hole (a tapered form). When the through hole has the above form, the cross-sectional form of the through hole at right angles with the moving direction of the glass is constant along the moving direction of the glass or slightly increasing toward the outlet during the shaping of a glass. When a glass having a low viscosity at the time of flowing out or when a mold formed of a material having high wettability to a glass is used, desirably, the through hole is adjusted to have a tapered form and the gradient of the tapered form is increased along the moving direction of a glass for preventing the fusion of the glass to the mold.

The glass shaped material as a base material for the crystallized glass material is obtained by melting glass raw materials and shaping a molten glass. However, the glass for constituting the above glass shaped material has the property of being easily crystallizable due to heat treatment as described above, and when this glass in a molten state is shaped into the glass shaped material, the glass devitrifies due to crystallization if the cooling rate is not set at an extremely high level. For preventing the above devitrification, the temperature of the molten glass at the time of flowing out is required to be set at a level fully higher than a devitrification temperature range and the glass that has flown into the mold is required to be rapidly cooled. In the process for the production of a glass shaped material, provided in the present invention, as shown in FIGS. 1 and 2, the mold 3 having a through hole is provided, and the through hole is filled with the molten glass 2 to bring the glass into contact with the inner wall surface of the through hole, so that the molten glass 2 is rapidly cooled by rapidly absorbing the heat of the glass. With a decrease in the area of the through hole inner wall surface per unit volume of the glass, the cooling rate of the glass is decreased. On the other hand, with an increase in the area of the through hole inner wall surface per unit volume of the glass, the cooling rate of the glass is increased. Therefore, the area of the through hole inner wall surface area per unit volume of the glass cast into the above mold 3, or the area of the through hole inner wall surface/the volume of the through hole, is preferably from 0.057 to 0.25 mm⁻¹, more preferably from 0.08 to 0.25 mm⁻¹, still more preferably from 0.13 to 0.25 mm⁻¹, particularly preferably from 0.13 to 0.2 mm⁻¹. Further, the length of the through hole along the moving direction of the glass is preferably 1/50 to 3 times the inner diameter of the through hole, more preferably 1/20 to twice the above inner diameter.

In the process for the production of a glass shaped material, provided by the present invention, the material for the mold 3 is preferably carbon, a casting or a refractory metal such as nickel. The step of producing the glass shaped material from the molten glass is preferably carried out in an inert atmosphere from the viewpoint of prevention of the deterioration of the mold 3.

The temperature of the mold 3 (inner wall of the through hole) is preferably determined by taking it into consideration that (1) a glass is not fused and that (2) the molten glass spreads inside the through hole without leaving any gap. The mold 3 may be provided with a heater and a condenser as required for temperature control. When the temperature of the glass shaped material surface in the outlet of the through hole is too high, the temperature is controlled by air-cooling the mold 3 or providing a water-cooled plate, and when the above temperature is too low, the temperature is controlled by heating the mold 3.

The molten glass 2 is caused to flow into the mold 3 through the pipe 1. When the glass has a high temperature at the time of its flowing out from the pipe 1, the glass viscosity is low and close to the viscosity of water. With a decrease in the viscosity of the glass, the difference between the velocity of glass flowing near the inner wall of the pipe 1 and the velocity of glass flowing along the central axis of the pipe 1 increases, and even if these glasses flow out of the pipe 1 at the same time, these glasses are not those that have flowed into the pipe 1 at the same time. For this reason, even if the glass flowing into the pipe 1 is a glass that is fully homogenized by stirring, the glass that flows out of the pipe 1 and the glass that has flowed into the pipe 1 are very slightly differ in composition. When the above glasses are mixed in the mold, a glass shaped material obtained comes to be very slightly non-uniform in composition, and such non-uniformity in composition is optically observed as striae. Even if the above non-uniformity in composition is very slight, it is undesirable for the production of a highly accurate crystallized glass material since a crystal phase precipitated in the crystallized glass material is rendered non-uniform.

In the process for the production of a glass shaped material, provided by the present invention, the molten glass 2 is caused to flow into the through hole of the mold arranged such that the central axis of the through hole is in the vertical direction as shown in FIG. 1 or 2, or the molten glass 2 is caused to flow into the through hole of the mold 3 arranged such that the central axis of the through hole is slanted relative to a horizontal, so that the turbulence of the glass flow does not easily take place when the molten glass 2 is cast into the mold 3. As a result, the striae caused by mixing glasses having slightly different compositions can be decreased or prevented, so that a remarkably highly homogeneous glass shaped material 4 can be obtained, which results in the production of a highly homogeneous crystallized glass material. For obtaining a more homogeneous glass shaped material, it is preferred to arrange the mold such that the through hole of the mold is in the vertical direction.

A glass cooled rapidly in the through hole is shaped into a form corresponding to the form of the through hole and is withdrawn from the outlet of the through hole, i.e., the outlet of the mold 3 at a predetermined rate.

As a method for controlling the withdrawal rate of the glass shaped material 4, there is a method in which that surface of the glass shaped material 4 withdrawn from the outlet of the through hole which is shaped by the inner wall of the through hole (circumferential surface of glass shaped material 4) is held to control the withdrawal rate. For example, a circumferential surface 6 of the glass shaped material is held between a plurality of rollers 5 as shown in FIG. 1 and the rotation rate of the rollers 5 are controlled in a state where the rollers 5 and the circumferential surface of the glass shaped material do not slip on each other, so that the moving rate of the glass shaped material in the downward direction can be controlled. As shown in FIG. 1, preferably, a plurality of pairs of the rollers 5 are arranged along the moving passage of the glass shaped material and the gravity working on the glass shaped material is separated and supported with the plurality of pairs of the rollers. Further, as shown in FIG. 1, it is preferred to arrange the above rollers 5 in a shaping furnace 7 to be described later.

In the above method, a glass shaped material that has passed the shaping furnace 7 can be cut or split in a lower portion while the glass shaped material 4 is being shaped, so that the productivity of the glass shaped material can be improved.

On the other hand, in the above method of controlling the withdrawal rate by holding the circumferential surface of the glass shaped material, when the force to holding the glass shaped material 4 with the rollers 5 is too large, the glass may be broken, so that the force over a predetermined force cannot be applied. When the glass shaped material 4 has a large weight, therefore, it is difficult to control the withdrawal rate since the glass shaped material 4 slips on the rollers. For avoiding such a situation, there can be employed a method in which the forward end of the glass shaped material withdrawn from the outlet of the through hole is supported with a support mechanism 10 thereby to control the withdrawal rate of the glass shaped material from the through hole.

In the method of controlling the withdrawal rate shown in any one of FIGS. 1 and 2, the liquid level of the molten glass in the mold 3 is monitored with a liquid level sensor 8 and a control signal is outputted from a controller 9, whereby the withdrawal rate can be controlled.

Meanwhile, there is a problem that when the glass shaped material 4 withdrawn from the mold 3 is rapidly cooled, a big temperature difference is caused between the circumferential surface of the glass shaped material and the central portion inside the glass shaped material and breaks the glass shaped material 4. It is therefore preferred to employ a constitution in which the shaping furnace 7 is provided beneath the outlet of the through hole, the ambient temperature in the shaping furnace 7 is set at a temperature near a glass transition temperature and the temperature difference between the surface of the glass shaped material 4 and the central portion inside it is gradually decreased thereby to prevent the breakage of the glass shaped material 4. In the glass shaped material 4 that passes the shaping furnace 7, not only a temperature difference between the surface and the central portion but also a strain can be also decreased.

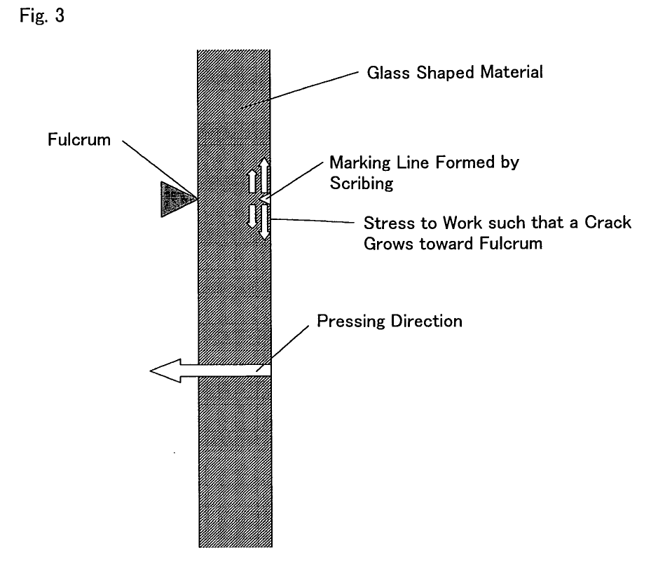

Then, the withdrawn glass shaped material is cut or split to a predetermined length. The method for splitting the glass shaped material is specially shown in FIGS. 3 to 5.

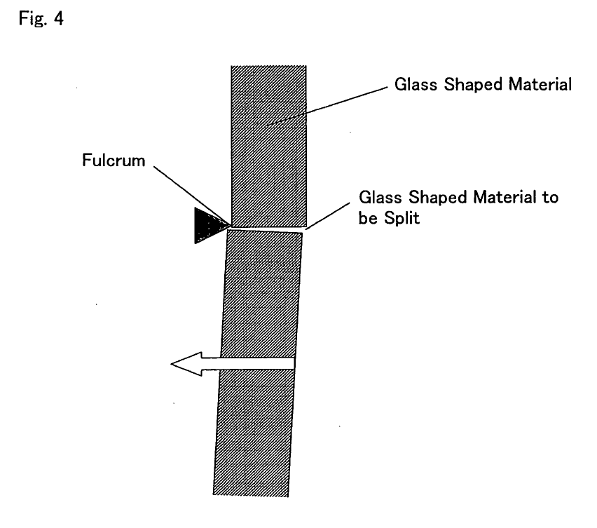

In an embodiment shown in FIG. 3, a marking line (ruling line) is formed on part of the circumferential surface of the glass shaped material in a predetermined position by scribing. The marking line is preferably formed in the direction perpendicular to the withdrawal direction of the glass shaped material. A fulcrum for locally supporting the glass shaped material is placed on that surface of the glass shaped material which is opposed to the above scribed position with regard to the central axis of the glass shaped material, and the movement of that portion of the glass shaped material which is higher than the fulcrum is limited by the fulcrum. And, a force in the horizontal direction is applied to that portion of the glass shaped material which is lower than the above scribed position, whereby the glass shaped material can be split in the scribed portion with the fulcrum being as a center as shown in FIG. 4.

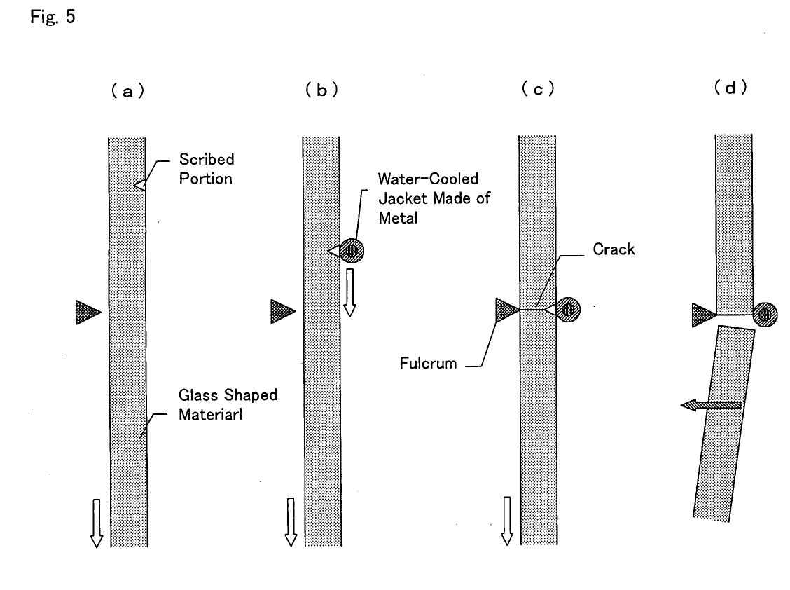

When a glass shaped material having a larger outer diameter is split, as shown in FIG. 5, a jacket made of a metal having a water passage formed therein is locally contacted to a scribed portion (FIG. 5(a), (b)) of the glass shaped material to cause a crack, which leads from a marking line into the glass, by a thermal impact, a circumferential surface opposed to the marking line with regard to the central axis of the glass shaped material is supported with a fulcrum (FIG. 5(c)) and a force in the horizontal direction is applied to that portion of the glass shaped material which is below the marking line, whereby a torque is exerted such that the crack grows toward the fulcrum and the glass shaped material can be split (FIG. 5(d)).

The thus-split or cut glass shaped material is then preferably annealed to decrease a strain.

In the process for the production of a glass shaped material, provided by the present invention, the straightness of the glass shaped material obtained per 1 m is preferably 2 mm or smaller. Further, the outer diameter tolerance of the glass shaped material is preferably ±0.25 mm or smaller.

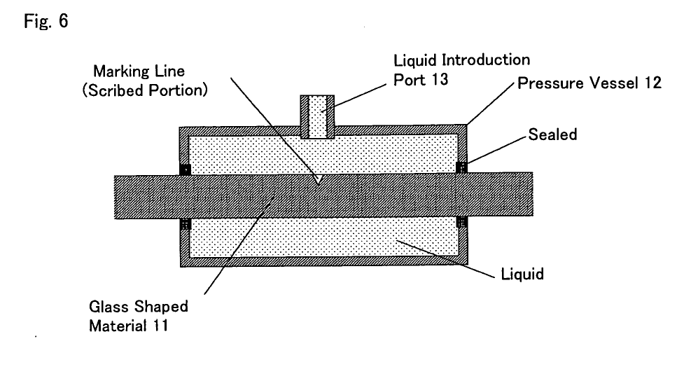

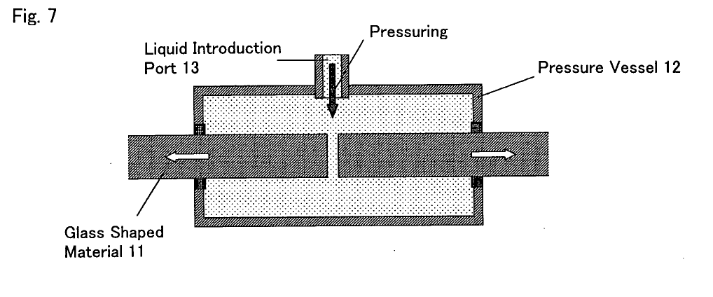

A lateral pressure cutting method that is particularly preferred as a method for splitting an annealed glass shaped material will be explained below with reference to FIGS. 6 and 7. As shown in FIG. 6, a rod-like glass shaped material 11 having a marking line formed by scribing in a circumferential surface portion where the glass shaped material 11 is to be split and a pressure vessel 12 are provided first, the glass shaped material 11 is inserted through opening portions of the pressure vessel 12 and the gap between the side wall of the pressure vessel and the glass shaped material and the other gap between the other side wall and the glass shaped material are sealed. The glass shaped material is arranged such that the above scribed portion is in the center of the pressure vessel 12, a liquid (preferably, water) is introduced into the pressure vessel 12 through a liquid introduction inlet 13 to fill the liquid in the pressure vessel, and the pressure of the liquid in the pressure vessel 12 is increased by further applying the pressure of additional liquid. In the pressure vessel 12, a pressure uniformly works on that circumferential surface of the glass shaped material 11 which is not scribed, while the above pressure works on the scribed portion so as to push open the scribed portion and the pressure causes a crack to grow in the direction perpendicular to the central axis of the glass shaped material 11 and divides the glass shaped material 11 in the scribed portion into two portions, whereby the glass shaped material can be split.

In the process of the production of a glass shaped material, provided by the present invention, the circumferential surface of the glass shaped material is preferably machined to render the glass shaped material columnar.

In the process of the production of a glass shaped material, provided by the present invention, a columnar glass shaped material having excellent straightness and a smaller outer diameter tolerance can be obtained without machining the circumferential surface when a mold having a columnar-cavity through hole is used. For producing higher-accuracy glass products by slicing a columnar glass shaped material, however, it is desirable to machine the circumferential surface of the glass shaped material in order to improve the straightness and bring the outer diameter tolerance close to zero.

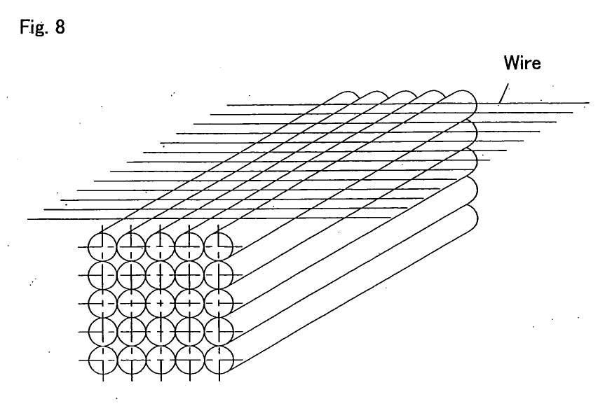

For example, when a plurality of columnar glass shaped materials having equal outer diameters are stacked such that they are aligned in the longitudinal direction as shown in FIG. 8 to slice them at the same time, glass shaped materials having poor straightness and large outer diameter tolerances cannot be stacked such that the central axes of them are in parallel with one another. When they are sliced in the above state, disk-like products are non-uniform in thickness or have poor roundness.

In the process for the production of a glass shaped material, provided by the present invention, therefore, it is preferred to machine the circumferential surface of the glass shaped material by grinding, polishing or the like so that the central axes of such glass shaped materials have a predetermined degree of parallelism when they are stacked such that they are aligned in the longitudinal direction.

As a method of machining the circumferential surface of the glass shaped material, known centerless grinding is preferred, and the above columnar glass shaped materials can be efficiently produced by centerless grinding.

With regard to the straightness of columnar glass shaped materials obtained by machining circumferential surfaces of glass shaped materials, the straightness of a glass shaped material having a length L (mm) is preferably 3×10⁻³×L (mm) or less, more preferably 2×10⁻³×L (mm) or less, still more preferably 5.0×10⁻⁵×L (mm) or less, yet more preferably 4.0×10⁻⁵×L (mm) or less, further more preferably 3.0×10⁻⁵×L (mm) or less, particularly preferably 2.8×10⁻⁵×L (mm) or less.

Further, the outer diameter tolerance of the columnar glass shaped material is preferably ±0.3 mm or smaller, more preferably ±0.25 mm or smaller, still more preferably ±0.2 mm or smaller, yet more preferably ±0.1 mm or smaller, further more preferably ±0.08 mm or smaller, particularly preferably ±0.05 mm or smaller.

The outer diameter of the columnar glass shaped material is preferably 16 to 70 mm, more preferably 16 to 50 mm, still more preferably 16 to 30 mm, particularly preferably 20 to 30 mm.

For improving productivity and for producing many disk-like glasses by a series of slicing procedures, the length L (mm) of the columnar glass shaped material is preferably 100 mm or more. However, when the space for a slicing apparatus and easiness in handling are taken into account, the above length is more preferably 1,000 mm or less, still more preferably 100 to 500 mm.

The glass for use in the process for the production of a glass shaped material in the present invention will be explained below.

As described already, the glass as a base material for the crystallized glass has a problem that since it has a glass composition that is so determined as to be suitable for crystallization treatment (heat treatment), the glass as a base material easily undergoes unintended crystallization when it is shaped into a glass shaped material. According to the process for the production of a glass shaped material, provided by the present invention, glass shaped materials obtained are effective for producing diverse crystallized glass materials. Of these, the following explanation will be concerned with a glass as a base material for obtaining a crystallized glass material that can realize a surface having remarkably high-level smoothness by polishing, that is free from the dropping of a crystal layer from a polished surface in ultrasonic cleaning, etc., and that has a large Young's modulus. In addition, contents of components by % stand for contents of components by mol % unless otherwise specified hereinafter.

The glass for use in the process for the production of a glass shaped material in the present invention includes a glass (amorphous glass) comprising SiO₂, MgO and TiO₂. A first glass that is particularly preferred is a glass comprising TiO₂, SiO₂ and MgO and having an SiO₂/MgO molar ratio of from 0.8 to 6.0 (to be referred to as “glass I” hereinafter).

TiO₂ works to generate a crystal nucleus when the base material is heat-treated. SiO₂ and MgO become components constituting a crystal phase of enstatite or an enstatite solid solution that precipitates in the heat treatment.

The SiO₂/MgO molar ratio is preferably from 0.8 to 6.0 for the following reason. Both when the above molar ratio is greater than the above range and when it is smaller than the above range, it is difficult to precipitate enstatite and/or an enstatite solid solution (to be referred to as “enstatite-based solid solution” hereinafter) by the heat treatment. The above SiO₂/MgO molar ratio is preferably from 1.0 to 6.0, more preferably from 1.0 to 5.0. The content of TiO₂ is preferably 5 to 15%.

As a glass for crystallization, it is preferred to use a glass fee of ZnO and Li₂O for keeping a spinel type crystal phase and a lithium disilicate crystal phase from precipitating. A glass containing Al₂O₃, ZrO₂, K₂O and Y₂O₃ in addition to SiO₂, MgO and TiO₂ and having an SiO₂, MgO, TiO₂, Al₂O₃, ZrO₂, K₂O and Y₂O₃ total content of 99 mol % or more is preferred, and a glass containing the above components and having the above total content of 100 mol % is more preferred.

Further, a glass having an SiO₂, MgO, TiO₂, Al₂O₃ and Y₂O₃ total content of 99 mol % or more is preferred, and a glass having the above total content of 100 mol % is more preferred.

However, it should be understood that Sb₂O₃ can be contained as a defoaming and refining agent besides the glass components.

The above glass I includes a glass containing 35 to 65% of SiO₂, over 5% to 20% of Al₂O₃, 10 to 40% of MgO and 5 to 15% of TiO₂ and having an SiO₂, Al₂O₃, MgO and TiO₂ total content of 92% or more.

The above glass is preferably free of ZnO and Li₂O for keeping a spinel type crystal phase and a lithium disilicate crystal phase from precipitating. A glass containing ZrO₂, K₂O and Y₂O₃ in addition to SiO₂, Al₂O₃, MgO and TiO₂ and having an SiO₂, Al₂O₃, MgO, TiO₂, ZrO₂, K₂O and Y₂O₃ total content of 99 mol % or more is preferred, and a glass having the above total content of 100 mol % is more preferred.

Further, a glass having an SiO₂, Al₂O₃, MgO, TiO₂ and Y₂O₃ total content of 99 mol % is preferred, and a glass having the above total content of 100 mol % is more preferred.

However, it should be understood that Sb₂O₃ can be contained as a defoaming and refining agent besides the glass components.

A glass containing the above components in the above ranges and having an Al₂O₃/MgO molar ratio of 0.2 or more but less than 0.5 is preferred, a glass containing 40 to 60% of SiO₂, 7 to 20% of Al₂O₃, 12 to 39% of MgO and 5.5 to 14% of TiO₂ is more preferred, and a glass having a TiO₂ content of 8 to 14% is still more preferred.

Of all of the above glasses, a glass containing Y₂O₃ is preferred, and when Y₂O₃ is introduced, the content of Y₂O₃ is preferably 10% or less, more preferably 0.1 to 10%.

Of all of the above glasses, a glass containing ZrO₂ is preferred, and when ZrO₂ is introduced, the content of ZrO₂ is preferably 10% or less, more preferably 1 to 10%, still more preferably 1 to 5%.

In all of the above glasses, the total content of alkali metal oxides is preferably 0 to 5%. Since, however, Li₂O is a factor that generates lithium disilicate as spherical crystal grains, it is preferred not to introduce Li₂O. As an alkali metal oxide, Na₂O and K₂O are preferred, and the total content of Na₂O and K₂O is preferably over 0% to 5%. Above all, it is more preferred to introduce K₂O alone as an alkali metal oxide.

When alkaline earth metal oxides other than MgO are introduced, a glass having a CaO, SrO and BaO total content of 0 to 5% is preferred, a glass having the above total content of 0 to 1% is more preferred and a glass having the above total content of 0% is still more preferred.

Further, the presence of even slight bubbles inside a magnetic disk substrate leads to a defective product. That is because bubbles that are caused to appear on the substrate surface by polishing form a dent and impair the flatness and smoothness of the substrate surface. It is therefore required to carry out sufficient defoaming of the glass, and Sb₂O₃ and As₂O₃ can be used as a refining agent effective for sufficiently carrying out the defoaming. When Sb₂O₃ and As₂O₃ are used, the total content of these is preferably 2% or less. Further, As₂O₃ has toxicity, so that it is preferred not to use As₂O₃ by taking account of an environmental impact. It is therefore preferred to introduce 0 to 2% of Sb₂O₃ as a refining agent, and it is more preferred to introduce over 0% but not more than 2% of Sb₂O_{3.}

Those glass components which constitute the above glasses will be explained in detail below.

SiO₂ is a component for forming a glass network structure, and it is also a component that constitutes enstatite having the composition of MgO.SiO₂ as a main crystal to precipitate and an enstatite solid solution having the composition of (Mg.Al)SiO₃. When the content of SiO₂ is less than 35%, a molten glass is very unstable, and hence it may not be possible to shape such a molten glass at a high temperature and the above crystal does not easily precipitate. Further, when the content of SiO₂ is less than 35%, a residual glass matrix phase (amorphous phase in a crystallized glass) is liable to be degraded in chemical durability and is liable to be also degraded in heat resistance. When the content of SiO₂ exceeds 65%, enstatite as a main crystal does not easily precipitate, and the Young's modulus of a crystallized glass tends to sharply decrease. The content of SiO₂ is therefore preferably in the range of 35 to 65% by taking account of a crystal species to precipitate, its precipitation amount, chemical durability, heat resistance and shapeability or productivity. The content of SiO₂ is more preferably in the range of 40 to 60% from the viewpoint that a crystallized glass having more preferred properties can be obtained. When SiO₂ is combined with some other component, a crystallized glass having a high Young modulus of 160 GPa or more can be also obtained while the glass is somewhat poor in surface flatness and smoothness. In this case, the content of SiO₂ may be preferably in the range of 35 to 55%.

Al₂O₃ is an intermediate oxide of the glass and contributes to an improvement in the surface hardness of the glass. When the content of Al₂O₃ is 5% or less, the chemical durability of the glass matrix phase decreases, and it is liable to be difficult to obtain the strength that a substrate material is required to have. When the content of Al₂O₃ exceeds 20%, enstatite as a main crystal does not easily precipitate, and further, the melting temperature of the glass is high, so that the glass is not easily melted. Further, the glass is liable to be devitrified and it is liable to be difficult to shape the glass. By taking account of the meltability of the glass, the high-temperature shapeability thereof and crystal species to precipitate, the content of Al₂O₃ is preferably in the range of over 5% to 20%, more preferably in the range of 7 to 20%. When Al₂O₃ is combined with some other component, a crystallized glass having a high Young modulus of 160 GPa or more can be also obtained while the glass is somewhat poor in surface flatness and smoothness. In this case, the content of Al₂O₃ may be preferably in the range of 9 to 20%.

MgO is a glass modifying component and it is also a main component of a crystal of enstatite having the composition of MgO.SiO₂ and an enstatite solid solution having the composition of (Mg.Al)SiO₃. When the content of MgO is less than 10%, the above crystal does not easily precipitate, the glass is highly liable to devitrify and the melting temperature increases, so that the operation temperature range for shaping the glass is liable to be narrowed. On the other hand, when the content of MgO exceeds 40%, the high-temperature viscosity of the glass is sharply decreased and the glass is thermally unstable. The glass is hence degraded in productivity, and the glass is also liable to be degraded in Young's modulus and durability. By taking account of the productivity, chemical durability, high-temperature viscosity, strength, etc., of the glass, the content of MgO is preferably in the range of 10 to 40%, more preferably in the range of 12 to 39%. When MgO is combined with some other component, a crystallized glass having a high Young modulus of 160 GPa or more can be also obtained while the glass is somewhat poor in surface flatness and smoothness. In this case, the content of MgO may be preferably in the range of 20 to 39%.

However, the contents of MgO and Al₂O₃ are adjusted such that the Al₂O₃/MgO molar ratio is less than 0.5. That is because when the Al₂O₃/MgO molar ratio is 0.5 or more, the Young's modulus of the glass tends to sharply decrease.

When the Al₂O₃/MgO molar ratio is adjusted to be less than 0.5, a crystallized glass having a high Young's modulus of 150 GPa or more can be also obtained, and the Al₂O₃/MgO molar ratio is more preferably less than 0.45. However, when the Al₂O₃/MgO molar ratio is too small, the high-temperature viscosity of the glass tends to decrease and the crystal grain size may grow large, so that the Al₂O₃/MgO molar ratio is preferably at least 0.2, more preferably at least 0.25.

TiO₂ is a nucleating agent for precipitation of a crystal phase of enstatite having the composition of MgO.SiO₂ and an enstatite solid solution having the composition of (Mg.Al) SiO₃. Further, when the content of SiO₂ is small, TiO₂ also has an effect on the suppression of devitrification of the glass. However, when the content of TiO₂ is less than 5%, the effect as a nucleating agent for a main crystal is not fully obtained, the glass surface is crystallized and it tends to be difficult to produce a uniform crystallized glass. When the content of TiO₂ exceeds 15%, the high-temperature viscosity of the glass is too low, and the glass is phase-separated or devitrified, so that the productivity of the glass tends to be extremely degraded. By taking account of the productivity, chemical durability, high-temperature viscosity, crystal nucleation, etc., of the glass, the content of TiO₂ is preferably 5 to 15%, more preferably 5.5 to 14%, still more preferably 8 to 14%. When greater importance is given to the Young's modulus than the surface flatness and smoothness, a crystallized glass having a high Young's modulus of 160 GPa or more can be obtained when TiO₂ is combined with some other component, and in this case the content of TiO₂ may be preferably 8.5 to 14%.

The above glass may contain Y₂O₃. When Y₂O₃ is introduced, the Young's modulus of the crystallized glass can be increased by approximately 10 GPa and the liquidus temperature thereof can be decreased by approximately 50 to 100° C. That is, when a small amount of Y₂O₃ is introduced, the glass can be remarkably improved in properties and productivity. When the content of Y₂O₃ is at least 0.1%, the above effect produced by the introduction of Y₂O₃ can be obtained. The content of Y₂O₃ is more preferably 0.3% or more, still more preferably 0.5% or more. However, Y₂O₃ has the power to suppress the growth of a main crystal to be contained in the above glass, so that when the content of Y₂O₃ is too large, surface crystallization is liable to take place in the heat treatment that is intended for the crystallization of the glass, and it is liable to be difficult to produce the crystallized glass as an end product. From the above viewpoint, the content of Y₂O₃ is preferably adjusted to 10% or less. In particular, the content of Y₂O₃ is more preferably 8% or less, still more preferably 3% or less.

Further, the above glass may contain 10% or less of ZrO₂. ZrO₂ improves the glass in stability, and in particular it can greatly work to improve the stability of a glass having a large content of MgO. Further, ZrO₂ also works as a nucleating agent, and as an auxiliary to TiO₂, it promotes the phase separation of the glass under pre-treatment and serves to form finer crystal grains. When the content of ZrO₂ exceeds 10%, however, the glass may be degraded in high-temperature meltability and homogeneity, so that the content of ZrO₂ is preferably 1 to 10%. Further, when the high-temperature meltability and the homogeneity of crystal grains are taken into account, the content of ZrO₂ is more preferably 0 to 6%, still more preferably 1 to 5%.

In the above glass, from the viewpoint of the maintenance of properties such as a high Young's modulus and homogeneous crystallinity, the total content of SiO₂, Al₂O₃, MgO and TiO₂ is preferably 92% or more, more preferably 93% or more, still more preferably 95% or more.

When the total content of SiO₂, Al₂O₃, MgO and TiO₂ is in the above range, the glass may contain components such as alkali metal oxide(s) R₂O (e.g., Li₂O, Na₂O, K₂O, etc.) and/or alkaline earth metal oxide(s) RO (e.g., CaO, SrO, BaO, etc.) so long as they do not impair the intended properties of the crystallized glass. As raw materials for the alkali metal oxide and/or alkaline earth metal oxide, corresponding nitrates can be used. Since the alkali metal oxide tends to decrease the Young's modulus, the content thereof is preferably limited to 5% or less. The alkaline earth metal oxide effectively decreases the melting temperature of the glass and effectively ionizes and dissolves platinum that is from a melting furnace made of platinum and included in the glass, and for this purpose, it is effective to add at least 0.1% of the alkaline earth metal.

Of the above alkali metal oxides, as is desirable, K₂O in particular has the effect of decreasing the melting temperature of the glass and has the effect of ionizing and dissolving platinum that is from a melting furnace made of platinum and included in the glass, and it also has the effect of keeping the Young's modulus from decreasing. When K₂O is incorporated, the content of K₂O is preferably 5% or less, more preferably 0.1 to 2%, still more preferably 0.1 to 1%.

When alkaline earth metal oxides other than MgO are incorporated, the content thereof is properly 5% or less, more preferably in the range of 0 to 1% since the alkaline earth metal oxides are liable to increase the crystal grain size. When the alkaline earth metal oxides are incorporated, the content thereof is preferably 0.1 to 5%, more preferably 0.1 to 2%, still more preferably 0.1 to 1%. Of the alkali metal oxides, it is preferred to introduce K₂O alone. In this case, the content of K₂O is preferably 0.1 to 5%, more preferably 0.1 to 2%, still more preferably 0.1 to 1%.

Further, the above glass is substantially free of ZnO and NiO. That is because ZnO let a hard crystal spinel easily form. Further, NiO is a component that let spinel easily form and has a detrimental effect on surroundings, and from this point of view, it is preferred not to incorporate NiO.

The preferred content ranges of the above components can be combined as required to obtain more preferred glass compositions, and specific examples of preferred combinations are as follows.

A glass composition containing 35 to 55% of SiO₂, 9 to 20% of Al₂O₃, 12 to 39% of MgO, 8 to 14% of TiO₂, 0 to 10% of Y₂O₃, 1 to 10% of ZrO₂, 0.1 to 2% of K₂O and 0 to 5% of total of other alkaline earth metal oxides different from MgO, the total content of SiO₂, Al₂O₃, MgO and TiO₂ being at least 93%.

A glass composition containing 35 to 55% of SiO₂, 9 to 20% of Al₂O₃, 12 to 39% of MgO, 8 to 14% of TiO₂, 0.1 to 10% of Y₂O₃, 1 to 10% of ZrO₂, 0.1 to 2% of K₂O, 0 to 5% of total of other alkaline earth metal oxides different from MgO, the total content of SiO₂, Al₂O₃, MgO and TiO₂ being at least 93%.

A glass composition containing 35 to 55% of SiO₂, 9 to 20% of Al₂O₃, 12 to 39% of MgO, 8 to 14% of TiO₂, 0.1 to 8% of Y₂O₃, 1 to 5% of ZrO₂, 0.1 to 1% of K₂O, 0 to 1% of total of other alkaline earth metal oxides different from MgO, the total content of SiO₂, Al₂O₃, MgO and TiO₂ being at least 93%.

A glass composition containing 35 to 55% of SiO₂, 9 to 20% of Al₂O₃, 20 to 39% of MgO, 8 to 14% of TiO₂, 0.1 to 3% of Y₂O₃, 1 to 5% of ZrO₂, 0.1 to 2% of K₂O, 0 to 1% of total of other alkaline earth metal oxides different from MgO, the total content of SiO₂, Al₂O₃, MgO and TiO₂ being at least 95%.

A glass composition containing 35 to 55% of SiO₂, 9 to 20% of Al₂O₃, 20 to 39% of MgO, 8 to 14% of TiO₂, 0.1 to 3% of Y₂O₃, 1 to 5% of ZrO₂, 0.1 to 1% of K₂O, 0 to 1% of total of other alkaline earth metal oxides different from MgO, the total content of SiO₂, Al₂O₃, MgO and TiO₂ being at least 95%.

Preferably, any one of the above glass compositions is free of Li₂O, ZnO, NiO, As₂O₃, PbO and F. In any one of the above glass compositions, the total content of SiO₂, Al₂O₃, MgO, K₂O, ZrO₂, Y₂O₃ and TiO₂ is still more preferably 99% or more, particularly preferably 100%. In addition, any one of the above compositions containing Sb₂O₃ alone as a refining agent is a still more preferred composition.

A second glass that is particularly preferred as a glass for use in the process for the production of a glass shaped material in the present invention is a glass which comprises SiO₂, Al₂O₃ and Li₂O and which is suitable for precipitation of a lithium dioxide crystal phase (to be referred to as “glass II” hereinafter).

The glass II is inferior to the glass I in processability by polishing and surface flatness and smoothness, and it cannot attain a high Young's modulus. Since, however, it can be used for a substrate for an information recording medium such as a magnetic disk, it is preferred to apply the process for the production of a glass shaped material, provided by the present invention, to the production thereof.

The above glass I and glass II can be produced by a known method. For example, a homogeneous glass free of bubbles, an un-dissolved substance and a foreign substance can be obtained by a high-temperature melting method, that is, a method in which predetermined amounts of glass raw materials are dissolved in air or in an inert gas atmosphere and a glass is homogenized by bubbling, adding a defoaming agent and stirring. While the temperature for melting the glass raw materials can be set at 1,400 to 1,650° C., the melting may be carried out at 1,500 to 1,650° C. Further, the melting may be carried out at 1,550 to 1600° C. For decreasing the melting temperature, it is preferred to introduce K₂O.

[Crystallized Glass Material]

The crystallized glass material of the present invention will be explained below.

The crystallized glass material of the present invention has a feature that it is obtained by heat-treating the glass shaped material and has a columnar form having a length L (mm), an outer diameter tolerance of ±0.2 mm or smaller and a straightness of 5×10⁻⁵×L (mm) or less.

In the present specification, the length L (mm) of the crystallized glass material means a length of a circumferential surface along the central axis of column of the crystallized glass material and can be univocally determined when the bottom surface of the column cross the above central axis at right angles. When the bottom surface is in any other case, it means a smallest length of lengths obtained by measuring circumferential surface of the column along the direction in parallel with the central axis of the column. Further, the outer diameter of the crystallized glass material means a diameter of a cross section (circle) perpendicular to the central axis of the above column, and the outer diameter tolerance as used herein means a tolerance determined on the basis of a maximum value and a minimum value of outer diameters measured at any point along the above length L (mm).

As is mentioned above, for highly accurately slicing a plurality of the crystallized glass materials at the same time when the crystallized glass materials are stacked such that they are aligned in the longitudinal direction, the length L (mm) of such crystallized glass materials is preferably 100 mm or more, more preferably 100 to 1,000 mm, still more preferably 100 to 500 mm. The reason therefor is that it is difficult to attain a predetermined straightness when the length of the crystallized glass material is too large and that the above length is desirable when it is intended to set a stacked structure of such crystallized glass materials on an apparatus for slicing.

The crystallized glass material of the present invention is required to have an outer diameter in a predetermined range in any portion thereof. For this reason, the outer diameter tolerance of the crystallized glass material of the present invention is ±0.2 mm or smaller, preferably ±0.1 mm or smaller, more preferably ±0.08 mm or smaller, still more preferably ±0.05 mm or smaller.

The slicing of the crystallized glass material takes a longer time than the slicing of a glass shaped material formed of an amorphous glass, so that it is preferred to use a crystallized glass material having a relatively small outer diameter as a base material for a magnetic disk substrate having a smaller diameter. Therefore, the outer diameter of the crystallized glass material is preferably 16 to 70 mm, more preferably 16 to 50 mm, still more preferably 16 to 30 mm.

In the crystallized glass material of the present invention, the straightness of the columnar crystallized glass material is 5×10⁻⁵×L (mm) or less, preferably 4.0×10⁻⁵×L (mm) or less, more preferably 3.0×10⁻5×L (mm) or less, still more preferably 2.8×10⁻⁵×L (mm) or less.

For example, when the length L (mm) is 180 mm, the straightness is 0.009 mm or less, preferably 0.0072 mm or less, more preferably 0.0054 mm or less, still more preferably 0.0050 mm or less.

Further, the circumferential surface of the crystallized glass material preferably has an average roughness Ra of 0.3 μm or less. When Ra is in that range, circumferential surfaces of such crystallized glass materials are brought into intimate contact with one another by stacking them such that they are aligned in the longitudinal direction, the central axes of the crystallized glass materials are in parallel with one another.

The crystallized glass material of the present invention has a columnar form, and when the edge where the circumferential surface and the bottom surface meet with each other is sharp, there may be caused a failure, for example, the crystallized glass material may be damaged when handled, so that it is preferred to chamfer the above edge portion, to chamfer an edge where the circumferential surface of the glass shaped material that is not yet crystallized and the bottom surface thereof meet or to constitute the above edge of a curved plane.

The crystallized glass constituting the crystallized glass material of the present invention will be explained below.

The crystallized glass constituting the crystallized glass material of the present invention is preferably an embodiment containing, as a crystal phase, enstatite and/or an enstatite solid solution. This embodiment will be explained below.

In recent years, the information recording density of a magnetic disk, i.e., a disk-like magnetic recording medium is more and more increasing, and for example, in a magnetic disk to be mounted on an information recording device of 60 gigabits/(inch)² or more (60×10⁹ bits/(inch)² or more), the size of a portion for recording 1 bit is approximately 35 nm×35 nm or less. When crystal grains (corresponding to individual crystal phases) in this portion (region) should fall off the substrate surface, data stored in this portion (region) is completely lost. For maintaining the reliability of a magnetic disk, therefore, it is required to prevent the crystal grains from coming off the substrate.

A substrate containing lithium disilicate as a crystal phase is useful as a magnetic disk substrate. However, crystal grains formed of lithium disilicate are nearly spherical and have the property of easily coming off the substrate if some force is exerted on the crystal grains of the substrate surface. A magnetic disk substrate is produced by polishing a crystallized glass substrate blank for rendering the surface thereof flat and smooth. In this polishing, the crystal grains forming and being near the surface and an amorphous phase around them are simultaneously polished. Suppose that one crystal grain is taken for an example. When a half of the crystal grain is polished off, the remaining grain is in a state where a semispherical particle is simply embedded in the amorphous phase and the particle hence easily comes off the surface. Crystal grains that are polished off by more than a half each also easily fall off. Crystal grains exposed on the substrate surface are numerous, and the number of crystal grains that are polished off by almost a half each or more than a half each is considerably large, so that when a material containing spherical crystal grains is used, stored data comes to be lost each time when a crystal grain comes off. Each crystal grain of lithium disilicate generally has a size of 5 to 50 nm in diameter at the smallest, and if one crystal grain comes off, it follows that the above portion (region) for storing one bit is lost.

On the other hand, in the material containing a crystal phase of enstatite and/or an enstatite solid solution, the ratio of the major diameter and miner diameter (major diameter/minor diameter) of the crystal grain can be rendered large, and the above ratio is preferably 3 or more, more preferably 3.5 or more, still more preferably 4 or more, yet more preferably 4.5 or more, particularly preferably 5 or more. A crystal phase in which the above ratio is so large may be called a crystal fiber rather than a crystal grain. Further, such crystal-fiber-like crystal phases can be connected to constitute a crystal phase having a two-dimensional extent. In the present specification, the above crystal phase is also referred to as crystal grain, and it can be said that in a crystallized glass material of this embodiment, crystal grains do not easily fall off the crystallized glass material surface due to the morphology of crystal grains. When a substrate is produced from a crystallized glass material formed of the above crystallized glass, the loss of magnetic recording regions caused by the separation of crystal grains from the substrate surface can be prevented, and the magnetic disk can be improved in reliability. In addition, the upper limit of the above major diameter/minor diameter ratio of the crystal grains is not specially limited, while a value of 20 or less can be a target of the upper limit.

The crystal grains can be measured for a major diameter and a minor diameter as follows. While a surface of a sample obtained by slicing a crystallized glass or that surface of a substrate formed of a crystallized glass which is to have a magnetic recording layer thereon (main surface of a substrate) is magnified through a transmission electron microscope, the surface is observed in the direction perpendicular to the surface. On the magnified image, the longest portions of narrow and long crystal grains are measured for lengths, which are taken as major diameters of the crystal grains, and lengths crossing the major diameters at right angles are measured for lengths, which are taken as minor diameters of the crystal grains.

The major diameter/minor diameter ratio of crystal grains of lithium disilicate is about 1, and such crystal grains easily fall off a substrate surface. However, when the major diameter/minor diameter ratio is 3 or more like crystal grains formed of enstatite and/or an enstatite solid solution, the separation of crystal grains from a substrate surface is decreased or prevented.

When crystal grains are measured for major and minor diameters through a transmission electron microscope, the crystal gains in a crystallized glass are observed in one direction. When the observing direction and the longitudinal direction of a crystal grain are the same, the major diameter/minor diameter ratio results in a small value, and when the observing direction comes across the above longitudinal direction at right angles, the major diameter/minor diameter ratio results in a large value. In the crystallized glass material of the present invention, however, the longitudinal directions of crystal grains constituting the crystallized glass are distributed at random, so that it can be reasonably considered that both the probability of all of the longitudinal directions of crystal grains being in the observing direction and the probability of all of the above longitudinal directions coming across the observing direction at right angles are substantially zero on the magnified image through a transmission electron microscope. Therefore, crystal grains having large values of the major diameter/minor diameter ratio are selected on the magnified image, and when the major diameter/minor diameter ratio is 3 or more, a crystallized glass containing crystal grains having such a ratio can be considered to be a crystallized glass according to this embodiment. The ratio of crystal grains (ratio of number of crystal grains) having a major diameter/minor diameter of 3 or more on the above magnified image is preferably 10% or more, more preferably 15% or more, still more preferably 20% or more.

Further, desirably, the ratio of crystal grains (ratio of number of crystal grains) having a major diameter/minor diameter ratio of 3.5 or more is 5% or more. More desirably, the ratio of crystal grains (ratio of number of crystal grains) having a major diameter/minor diameter ratio of 4 or more is 5% or more. Still more desirably, the ratio of crystal grains (ratio of number of crystal grains) having a major diameter/minor diameter ratio of 4.5 or more is 5% or more. Particularly desirably, the ratio of crystal grains (ratio of number of crystal grains) having a major diameter/minor diameter ratio of 5 or more is 5% or more.

An enstatite-based crystal grain is formed of Si, Mg and O, and as a crystal structure it has a chain-like structure in which Si and O are repeatedly connected. And, a plurality of Si—O chain-like structures are connected through Mg or O to form a structure in which the chain-like structures spread in a sheet-like state. However, the bonding of the chain-like structures through Mg or O has low strength and is easily broken. On the other hand, the Si—O chain-like structure has high strength in its extending direction, so that the above crystal species has a structure in which chain-like crystal grains are woven. When enstatite crystal grains are partially exposed on a substrate surface, therefore, the crystal grains are strongly bounded to the substrate with an amorphous phase constituting part of a crystallized glass, so that the above separation of the crystal grains can be prevented.

Enstatite has low hardness (Mohs hardness of 5.5), so that a crystallized glass containing enstatite or a solid solution thereof, in particular a crystallized glass in which the volume of a crystal phase formed of enstatite or an enstatite solid solution is the largest among crystal phases (crystallized glass containing enstatite or an enstatite solid solution as a main crystal) or a crystallized glass in which the volume of a combination of a crystal phase formed of enstatite and a crystal phase formed of an enstatite solid solution is the largest among crystal phases (crystallized glass containing enstatite and an enstatite solid solution as a main crystal) has a characteristic feature that it is easily polishable and attains a predetermined surface roughness for a relatively short period of time. Further, it is considered that enstatite can give a high Young's modulus even if crystal grains thereof have small sizes since the crystal grains are embedded in an amorphous phase due to its crystal morphology in which the chain-like structures are connected in a sheet-like form. This enstatite includes clinoenstatite and protoenstatite.

Further, when other crystal species is contained, other crystal grains are strongly bound to a substrate due to the above structure of the enstatite-based crystal grains, so that the separation of the crystal grains from the substrate surface is prevented. Preferably, however, no spinel is contained as a crystal phase. That is, a spinel crystal phase has high hardness (Mohs hardness of 8) and there is caused a difference between the polishing rate of the crystal phase and that of an amorphous phase when the substrate surface is polished, so that a substrate containing the spinel crystal phase easily causes the formation of surface projections and the separation of crystal grains.

Examples of the crystal species of crystal grains of which the separation is highly effectively prevented by the enstatite-based crystal grains include a quartz solid solution and a titanate. Preferred are therefore a crystallized glass containing crystal grains formed of a quartz solid solution in addition to crystal grains formed of enstatite and/or an enstatite solid solution, a crystallized glass containing crystal grains formed of a titanate in addition to crystal grains formed of enstatite and/or an enstatite solid solution and a crystallized glass containing crystal grains formed of a quartz solid solution and crystal grains formed of a titanate in addition to crystal grains formed of enstatite and/or an enstatite solid solution.

When a crystallized glass contains other crystal phase different from the enstatite-based crystal phase for satisfying various properties that a magnetic disk substrate is required to have and attaining the above effect of preventing the separation of crystal grains, desirably, the crystal species (to be referred to as “main crystal” hereinafter) that has the largest content by volume % in the crystallized glass is enstatite and/or an enstatite solid solution. In particular, more preferred is a crystallized glass in which the total content of enstatite and/or a solid solution thereof is 70 to 90% by. volume, the content of a titanate is 10 to 30% by volume and the total content of enstatite and/or the solid solution thereof and the titanate is 90% by volume or more. In addition, there are a crystallized glass containing a quartz solid solution in a crystal phase and a crystallized glass containing no quartz solid solution.

The enstatite crystal phase has the above-described crystal structure, and the weakly bonding chain-like structures are hence separated when the surface is polished, so that there can be realized a surface excellent in flatness and smoothness.

The crystal phases dispersed in the crystallized glass are those which are precipitated in the glass by heat-treatment of the amorphous glass (base material glass).

In the above embodiment, the Young's modulus of the crystallized glass is preferably 130 GPa or more, more preferably 140 GPa or more, still more preferably 160 GPa or more. By increasing the Young's modulus, the stability of a magnetic disk against high-speed rotation can be obtained, and in particular, excellent stability of a thickness-decreased magnetic disk against high-speed rotation can be obtained. The above Young's modulus values are about twice the value of Young's modulus of an Li₂O—SiO₂-crystallized glass such as a lithium disilicate crystallized glass. Further, the crystallized glass preferably has a specific modulus (value obtained by dividing a Young's modulus by a density) of 37 MN·m/kg or more for obtaining stability against high-speed rotation.

It is considered that the presence of the enstatite crystal phase also contributes to the realization of the high Young's modulus. In the enstatite crystal phase, the chain-like structure has high bonding strength in the direction of the chain-like structure in the crystal. It is considered that since a number of such crystal fiber structures are dispersed at random, the above properties can be accomplished.

When a magnetic disk is incorporated into an information recording device, a clamp for fixing the magnetic disk is made of a metal such as stainless steel, so that it is desirable to provide a crystallized glass having a thermal expansion coefficient close to that of such a metal material. By further taking account of various properties that the above substrate is required to have, the average thermal expansion coefficient of the above crystallized glass at 100 to 300° C. is preferably 50×10⁻⁷/° C. or more, more preferably 50×10⁻⁷ to 120×10⁻⁷/° C., still more preferably 55×10⁻⁷ to 110×10⁻⁷/° C., particularly preferably 60×10⁻⁷ to 100×10⁻⁷/° C.

The size, number density and crystallinity of the crystal grains in the crystallized glass influence various properties of the substrate. These values can be indirectly evaluated by the use of transmittance. When the above evaluations are carried out, the transmittance of the crystallized glass to light having a wavelength of 600 nm when it has a thickness of 1 mm is preferably at least 10%, more preferably at least 20%, still more preferably at least 50%.

The crystal content (crystallinity) in the crystallized glass is preferably 20 to 70% by volume. Further, the crystallinity is more preferably 50% by volume or more for obtaining a substrate having a high Young's modulus. By taking account of easiness in post steps (grinding and polishing of a substrate) after the crystallization, however, the crystallinity may be 20 to 50% by volume or further may be 20 to 30% by volume. When importance is attached to a high Young's modulus rather than to the easiness in the post steps, the crystallinity may be 50 to 70% by volume. The size of the crystal grains in the crystallized glass is preferably 100 nm or less, more preferably 50 nm or less. As a target, the size of the crystal grains may be particularly preferably 1 to 50 nm or may be more desirably 1 to 40 nm. The size of the crystal grains corresponds to the major diameter described already.

When the size of the crystal grains exceeds 100 nm, not only the mechanical strength of the glass is decreased, but also, when the glass is polished, a crystal grain may fall off to degrade the surface smoothness of the glass. The above size of the crystal grains can be mainly controlled on the basis of types of crystal phases to be contained and conditions for heating the glass shaped material.

Examples of the crystallized glass of the present invention not only include a crystallized glass containing an enstatite crystal phase but also include a crystallized glass containing lithium disilicate as a crystal phase, a crystallized glass containing cordierite as a crystal phase and a crystallized glass containing eucryptite as a crystal phase, while the crystallized glass containing an enstatite crystal phase is the most preferred as described already.

The crystallized glass of the present invention has the form of a column or the like, and when the edge where the circumferential surface and the bottom surface meet with each other is sharp, there may be caused a failure, for example, the crystallized glass may be damaged when handled, so that it is preferred to chamfer the above edge portion, to chamfer an edge where the circumferential surface of the glass shaped material and the bottom surface thereof meet or to constitute the above edge of a curved plane.

[Process for the Production of Crystallized Glass Material]

The process for the production of a crystallized glass material, provided by the present invention, will be explained below. The process for the production of a crystallized glass material, provided by the present invention, comprises heat-treating a glass shaped material produced by the above proves for the production of a glass shaped material in the present invention, to obtain a crystallized glass material having a crystal phase precipitated in the entirety of a use region.

In the process for the production of a crystallized glass material, provided by the present invention, when it is intended to produce a magnetic disk substrate blank from a crystallized glass material to be obtained, it is preferred to use a columnar glass shaped material as a glass shaped material, and when it is intended to produce a thin-plate-like glass having other form, it is preferred to use, as a glass shaped material, a columnar glass shaped material having a cross-sectional form equivalent to the form of the main surface of the thin plate.

The heat treatment of a columnar glass shaped material for obtaining the crystallized glass material will be explained below.

First, there is prepared a columnar glass shaped material produced by the process for the production of a glass shaped material, provided by the present invention. When the glass is crystallized, first, the glass is phase-split by heat treatment to precipitate a number of crystal nuclei in the glass. Then, the glass is gradually temperature-increased to a temperature higher than the temperature employed for the above phase splitting step, to grow the crystal nuclei, whereby a number of predetermined crystal phases are dispersed in the glass shaped material formed of an amorphous glass. Then, the above glass shaped material is cooled at a temperature decrease rate at which the glass shaped material is not damaged, to complete the crystallization.

In a series of the above steps, the base material glass slightly shrinks in volume. When the volume shrinkage takes place uniformly in the entire crystallized glass material, there would be no problem. When the volume shrinkage takes place non-uniformly, an obtained crystallized glass material is degraded in straightness even if a columnar glass shaped material is used. As a result, it is required to machine the circumferential surface of the crystallized glass material for improving it in straightness. A crystallized glass has an increased hardness and its machining takes an additional time and labor, which is disadvantageous for mass-producing highly accurate disk-like products highly productively.

For producing disk-like products having high parallelism and flatness by slicing a columnar crystallized glass material, it is important to be as free of impairment of the straightness of the columnar glass shaped material as can be.

The base material glass constituting the glass shaped material is phase-split by heating the glass shaped material at a temperature around the glass transition temperature and the step of growing crystal nuclei is carried out at a higher temperature, so that the viscosity of the glass is decreased to such an extent that the glass is deformed by an external force. When the glass shaped material is heat-treated in a state where part thereof is held, therefore, the straightness of the glass shaped material is decreased by deformation caused by the weight of its own.

Therefore, the heat treatment of the columnar glass shaped material is preferably carried out while it is rotated in the circumferential direction about the central axis of the column as a center. When the glass shaped material is held in the above manner, the glass shaped material can be uniformly heated on the circumference thereof around the central axis thereof, and the volume shrinkage of the glass can be rendered uniform around the central axis of the column. When the glass shaped material is held and heated for crystallization while it is rotated in the circumferential direction about the central axis of the column as a center and when the crystallized glass material is produced while the straightness of the glass shaped material is thus maintained, the glass shaped material can be crystallized while the straightness can be maintained as much as possible. The crystallization in the above manner is also preferred for improving the uniformity of the crystal phase so that a magnetic disk blank having a constant product quality can be obtained.

The above rotation of the glass shaped material is carried out in a state where the circumferential surface thereof is held. In this case, preferably, the circumferential surface of the glass shaped material is held along the entire length in the central axis direction thereof.

The method of holding the glass shaped material while it is rotated in the circumferential direction about the central axis of the column as a center includes a method in which the glass shaped material is placed on a plurality of refractory rollers arranged at intervals of distance that is smaller than the outer diameter of the glass shaped material and the crystallized glass material and the above rollers are rotated to rotate the glass shaped material and a method in which a plurality of the glass shaped materials are arranged on a plane such that the central axes of their columns are in parallel and the glass shaped materials are rolled on the plane to rotate them. Further, the glass shaped material can be also rotated by the following method. The glass shaped material is inserted into a refractory cylinder having an inner diameter larger than the outer diameter of the glass shaped material, and the central axis of the cylinder and the central axis of column of the glass shaped material are rendered parallel with each other. In this state, the central axis of the cylinder is rendered horizontal or inclined from a horizontal, and it is arranged that the glass shaped material does not slip out of the cylinder. Then, the cylinder is rotated about the central axis thereof, whereby the glass shaped material is rolled along the inner circumferential surface of the cylinder and is hence rotated about the central axis of the column thereof as a center.

In any one of the above rotating methods or any other rotation method, preferably, the glass shaped material is continuously rotated at a constant rotation rate until the crystallized glass material is obtained.

For preventing the deformation of the glass shaped material, preferably, the inclination angle of the central axis of the glass shaped material from a horizontal is rendered small, and more preferably the above central axis is rendered horizontal.

The material for the above rollers, the material for forming the plane on which the glass shaped material is to be rolled and the material for constituting the cylinder are preferably silicon carbide or the like for a reason that the glass is not easily melt-fused and that it has high heat resistance.

The glass shaped material is preferably thermally treated in a heating furnace, and the temperature distribution in the furnace is preferably rendered uniform. Further, when the glass shaped material is heat-treated in the furnace while it is rotated, the inside of the furnace may be divided into a plurality of zones, and the temperature of each zone may be independently set. In this case, desirably, the temperature distribution of each zone is rendered uniform.

The rotation rate of the glass shaped material can be determined as required depending upon the setting method and set temperature of a heater in the furnace, dimensions of the glass shaped material, and the like. In this case, heat treatment is carried out under several rotation rate conditions, and there is selected a condition under which an obtained crystallized glass material comes to have a high straightness. The straightness as a target can be the straightness of the crystallized glass material of the present invention.

For obtaining a crystallized glass material having high straightness and outer diameter accuracy, while it is taken into account that the form is not impaired in the heat treatment step, it is desirable to improve the glass shaped material in straightness and outer diameter accuracy.

In the process for the production of a crystallized glass material, provided by the present invention, there is used the glass shaped material having the predetermined straightness and the predetermined outer diameter tolerance, which is produced by the process for the production of a glass shaped material, so that the rotation rate of the glass shaped material during the thermal treatment can be highly accurately controlled.

The crystallized glass material obtained preferably has an outer diameter and a length which are equivalent to the outer diameter and length of the corresponding glass shaped material. Since, however, the glass shaped material shrinks in volume in the heat treatment step as described already, it is preferred to use a glass shaped material having dimensions that are larger by decrements caused by the volume shrinkage.

For obtaining a crystallized glass material having a circumferential surface with a small surface roughness, there may be used a glass shaped material whose circumferential surface (side surface) is pre-machined so that the average roughness Ra of the circumferential surface is decreased. When the glass shaped material whose circumferential surface is not machined is thermally treated, the circumferential surface is preferably machined as required after the thermal treatment. In this case, the straightness and outer diameter tolerance of the thus-obtained crystallized glass material are preferably in the ranges of those of the above glass shaped material whose circumferential surface is machined.

The process for the production of a crystallized glass material, provided by the present invention, will be explained below with regard to a crystallized glass material containing an enstatite crystal phase.

First, the glass shaped material is subjected to a phase-splitting step and a crystallization step by heating it at temperatures in the range of (Tg−35° C.) to (Tg+60° C.) in which Tg is a glass transition temperature of the above base material glass.

In the above heat treatment step, at an initial stage, the glass shaped material is heated at a relatively low temperature, for example, between (glass transition temperature (Tg) of the base material glass−35° C.) and (Tg+60° C.), preferably between (Tg−35° C.) and (Tg+60° C.), more preferably between Tg and (Tg+60° C.), to generate numerous crystal nuclei. These temperatures are specifically in the range of 700 to 850° C. Then, the temperature is increased to 850° C. to 1,150° C. to grow the crystal, which is preferred for forming a finer crystal. In this case, after the glass has a temperature of 500 to 850° C., the temperature is more preferably increased at a temperature elevation rate of 0.1 to 10° C./minute for precipitation of fine crystal grains and prevention of deformation of a plate-like glass. While the temperature elevation rate before the glass has a temperature of 500 to 850° C. is not specially limited, it is preferably 5 to 50° C./minute. In the above process, the production step for the crystallization can be easily controlled since the tolerable temperature range has a temperature width of 30° C. or more with regard to the thermal treatment for forming the crystal nuclei and the thermal treatment for growing the crystal for producing a crystallized glass having the same Young's modulus and the same crystal grains size or having the same crystallization uniformity.

In the above crystallization step, it is preferred to employ thermal treatment conditions under which enstatite having the composition of MgO.SiO₂ and an enstatite solid solution having the composition of (Mg.Al) SiO₃ are precipitated as a main crystal by the thermal treatment. As the above conditions, the temperature for the thermal treatment for the crystallization is preferably 850 to 1,150° C., more preferably 875 to 1,050° C. When the thermal treatment temperature is lower than 850° C., enstatite and a solid solution thereof do not easily precipitate. When it exceeds 1,150° C., other crystal different from the enstatite and the solid solution thereof is liable to precipitate. Further, when the thermal treatment temperature is set at 875 to 1,050° C., the average grain size of the enstatite and/or the solid solution thereof can be rendered relatively small, for example, 100 nm or less, preferably 50 nm or less. The thermal treatment time period for the crystallization works on the crystallinity and the size of crystal grains in relation to the thermal treatment temperature and can be selected depending upon a predetermined crystallinity and predetermined size of crystal grains. At a thermal treatment temperature of 850 to 1,150° C., the thermal treatment is preferably carried out for 1 to 4 hours.

[Process for the Production of Magnetic Disk Substrate Blank]

The process for the production of a magnetic disk substrate blank, provided by the present invention, will be explained below.

A first embodiment (to be referred to as “magnetic disk substrate blank production process I” hereinafter) of the process for the production of a magnetic disk substrate blank, provided by the present invention, comprises slicing a glass shaped material produced by the process for the production of a glass shaped material, provided by the present invention, perpendicular to the longitudinal direction of said glass shaped material and then thermally treating a sliced glass piece to obtain a magnetic disk substrate blank having a crystal phase precipitated in the entirety of a use region.

The method for slicing the glass shaped material is preferably a method using a slicing apparatus called a multi-wire saw. The above slicing apparatus has a constitution in which a plurality of wires are arranged on one plane such that the wires are in parallel with one another and at equal intervals in a region where the glass shaped material as a work is to be sliced, the wires are laid on a plurality of rollers such that they can rotate in the length direction thereof and the wires repeatedly move across the above region at a constant pitch. And, in the above region where the glass shaped material is to be sliced, the central axis of the glass shaped material is aligned in position so as to cross the length direction of the wire at right angles, and the wires are pressed on the circumferential surface (side surface) of the glass shaped material while the wires are operated in the length direction at a constant speed, to slice the glass shaped material. In this case, there may be employed a constitution in which the position of the wires is fixed and the glass shaped material as a work is moved to slice it, a constitution in which the glass shaped material as a work is fixed and the wires are moved or a constitution in which the wires and the work are moved.

The glass shaped material as a work may be sliced while it is immersed in a slurry or may be sliced in a dry state.

The moving rate of the wires can be determined by taking account of dimensions of the glass shaped material, dimensions of the crystallized glass substrate blank and mechanical properties. As a multi-wire saw, a commercially available multi-wire saw can be used.

Disk-like glass shaped materials obtained by the slicing are cleaned to obtain magnetic disk substrate blanks. According to the above process, a number of magnetic disk substrate blanks can be produced by one operation of the slicing.

For improving the productivity more, preferably, a stack structure of glass shaped materials is constituted and the stack structure is sliced. In the process for the production of a magnetic disk substrate blank, provided by the present invention, a stack structure of glass shaped materials produced by the process for the production of a glass shaped material, provided by the present invention, so that the central axes of the glass shaped materials can be allowed to highly accurately cross the wires at right angles and that there can be hence obtained magnetic disk substrate blanks excellent in parallelism and flatness.

When the number of the glass shaped materials for forming the stack structure is small, preferably, each layer is formed from glass shaped materials in a quantity of a certain number and such layers are stacked to constitute the stack structure as shown in FIG. 8. This stack structure is sliced in the direction perpendicular to each layer, whereby the glass shaped materials constituting the stack structure can be simultaneously cut, and if cutting conditions such as a slicing rate are rendered constant, stable slicing can be carried out. In an embodiment shown in FIG. 8, the glass shaped materials constituting the stack structure are stacked in a manner in which the central axes of the glass shaped materials form the lattice of squares when the glass shaped materials are viewed in the central axes of them.

When the number of glass shaped materials for constituting a stack structure is large, preferably, the numbers of the glass shaped materials constituting layers are decreased toward an upper portion of the stack structure. With an increase in the number of the glass shaped materials, generally, the slicing stability decreases. By stacking the glass shaped materials while the numbers of them are gradually decreased toward the upper portion of the stack structure, the center of gravity of the structure can be lowered, so that a stable stack structure can be obtained. In a more preferred embodiment, when the glass shaped materials constituting the stack structure are viewed in the direction of their central axes, the glass shaped materials have a stack structure in which they are stacked such that their central axes form the lattice of regular triangles. When this stack structure is viewed in the above direction, it constitutes a closest packing structure of the glass shaped materials.

When the stack structure is prepared, with an epoxy adhesive, each of the glass shaped materials is closely bonded to neighboring ones and the stack structure as a work is bound and fixed on a bed. After the work is sliced, the adhesive adhering to the work is removed by dissolving with an organic solvent, cleaned and dried to obtain disk-like glass shaped materials.

Meanwhile, the main surface of a magnetic disk substrate is required to have high parallelism and high flatness. For producing the above substrate by polishing, the parallelism (variability obtained by measuring the thickness of center of a main surface and thicknesses of equally selected four portions or more in peripheral portions) and flatness of the main surface of a crystallized glass substrate blank are desirably predetermined values or less. In the process for the production of a crystallized glass substrate blank, provided by the present invention, therefore, the parallelism of main surface of the crystallized glass substrate blank obtained is preferably 10 μm or less, more preferably 5 μm or less, still more preferably 3 μm or less, particularly preferably 1 μm or less. Further, the flatness of main surface of the crystallized glass substrate blank is preferably 15 μm or less, more preferably 10 μm or less, still more preferably 5 μm or less, particularly preferably 3 μm or less, further preferably 2 μm or less.

In the magnetic disk substrate blank production process I, provided by the present invention, disk-like glass shaped material(s) obtained by the slicing is/are thermally treated to precipitate a crystal phase in the entirety of a use region.

In this case, when the heat-treatment of the disk-like glass shaped material obtained by the slicing is non-uniform, the volume shrinkage during crystallization becomes non-uniform and the disk-like glass shaped material is distorted. It is therefore desirable to render the temperature distribution in a heating furnace as uniform as possible, and it is desirable to uniformly heat both the main surfaces of the disk-like glass shaped material. For heat-treating a number of thin plates at once, further, there may be employed a constitution in which flat plates formed of ceramic such as silicon carbide or the like, which are not likely to be heat-fused to the glass, and the disk-like glass shaped materials are alternately stacked and the thus-prepared stack structure is allowed to move inside a roller house kiln type heating furnace while maintained horizontally, to carry out the heat treatment.

The heating temperature for the crystallization is the same as those temperatures which have been explained with regard to the process for the production of a crystallized glass material, provided by the present invention, and the crystallized glass constituting the magnetic disk substrate blank obtained is the same as the glass which has been already explained with regard to the process for the production of a crystallized glass material, provided by the present invention.

A second embodiment (to be referred to as “magnetic disk substrate blank production process II” hereinafter) of the process for the production of a magnetic disk substrate blank, provided by the present invention, comprises slicing a crystallized glass material produced by the above process for the production of a crystallized glass material, provided by the present invention, or the crystallized glass material of the present invention perpendicular to the longitudinal direction of the above crystallized glass material.

In the magnetic disk substrate blank production process II of the present invention, the method for slicing the crystallized glass material is specifically the same as those methods which have been explained with regard to the magnetic disk substrate blank production process I.

The magnetic disk substrate blank production processes I and II differ in that the heat treatment for crystallization is carried out before or after the slicing. When a glass is difficult to slice after the crystallization, the magnetic disk substrate blank production process I of the present invention is preferred. When a glass can be sliced after the crystallization and if a glass shaped material can be uniformly heat-treated, the magnetic disk substrate blank production process II of the present invention is preferred since the productivity is improved.

[Process for the Production of Magnetic Disk Substrate]

The process for the production of a magnetic disk substrate, provided by the present invention, comprises polishing the main surface(s) of a magnetic disk substrate blank produced by the process for the production of a magnetic disk substrate blank, provided by the present invention.

The main surface(s) as used herein refers to largest-area surface(s) of a magnetic disk substrate blank or opposed two surfaces newly formed by the slicing during the production of a magnetic disk substrate blank.

The above substrate blank is machined by known grinding, precision polishing and processing of inner and outer diameter portions. The main surface(s) of the substrate blank can be polished, for example, by a known method using synthetic abrasive grains of synthetic diamond, silicon carbide, aluminum oxide or boron carbide or natural abrasive grains of natural diamond or cerium oxide.

The substrate preferably has a finished surface having surface flatness and smoothness represented by an average roughness Ra (JIS B0601) of 1 nm or less, measured with an atomic force microscope (AFM). The average roughness Ra (JIS B0601) of the surface greatly influences the recording density of a magnetic disk, and when the surface average roughness exceeds 1 nm, it is difficult to attain a higher recording density. By taking account of attainment of a higher recording density, the above Ra is preferably 0.7 nm or less, more preferably 0.5 nm or less, still more preferably 0.3 nm or less.

A magnetic disk substrate formed of a crystallized glass containing an enstatite crystal phase has high strength, high hardness and a high Young's modulus and is excellent in chemical durability and heat resistance, so that the above magnetic disk substrate is useful as such. Further, the above substrate is free of alkali or low-alkali or it contains only K₂O as an alkali metal oxide, so that the corrosion of films such as a magnetic recording film and the like can be remarkably reduced and that the magnetic recording film can be hence maintained in an excellent state.

A magnetic disk substrate is severely required to be in a clean condition and it is hence preferred to clean the substrate at a final step or at an intermediate step as required. In this case, ultrasonic cleaning is preferably carried out for efficiently cleaning the substrate. The ultrasonic cleaning can be carried out under known conditions. In the crystallized glass substrate containing an enstatite crystal phase, crystal grains of the substrate surface do not easily fall off, so that the crystal grains of the substrate surface do not fall off together with fouling during the ultrasonic cleaning.

Unlike a magnetic disk substrate formed of an amorphous glass, the magnetic disk substrate formed of the crystallized glass has a feature that since it has sufficient mechanical strength without being chemically strengthened, the thickness of the substrate can be decreased. The thickness of the substrate is preferably 0.4 mm or less, more preferably 0.3 mm or less, still more preferably 0.28 mm or less, further more preferably 0.1 to 0.25 mm. The substrate preferably has the form of a disk, and it preferably has a circular hole in the center thereof for attaching it to a recording device. The outer diameter of the substrate is preferably 16 to 70 mm, more preferably 16 to 50 mm, still more preferably 16 to 30 mm, further more preferably 20 to 30 mm.

[Process for the Production of Magnetic Disk]

The process for the production of a magnetic disk, provided by the present invention, comprises forming a magnetic recording layer on a magnetic disk substrate produced by the above process for the production of a magnetic disk substrate, provided by the present invention.

The magnetic recording layer is also called a magnetic layer. Other layers different from the magnetic layer from the viewpoint of functions include an undercoat layer, a protective layer, a lubricant layer, etc., and they are formed as required. These layers can be formed by various thin film forming techniques such as a sputtering technique, and the like.

Although not specially limited, the material for the magnetic layer includes a Co-containing material, a ferrite-containing material, and an iron-rare earth metal-containing material. The magnetic layer may be any one of magnetic layers for use in magnetic recording methods such as a longitudinal magnetic recording method and a perpendicular magnetic recording method. As a magnetic layer, there is a magnetic thin film formed of a CoPt alloy containing Co as a main component, a CoCr alloy, a CoCrTa alloy, a CoPtCr alloy, a CoCrPtTa alloy, a CoCrPtB alloy, a CoCrPtSiO alloy or the like. The magnetic layer may have a multi-layer constitution in which the magnetic layer is divided by a non-magnetic layer for noise reduction.

The material for the undercoat layer is selected depending upon a material for the magnetic layer. Examples of the material for the undercoat layer include at least one material selected from Cr, Mo, Ta, Ti, W, V, B, Al, etc., and oxides, nitrides, carbides, etc., of these metals. When the magnetic layer is mainly composed of Co, the material for the undercoat layer is preferably a Cr alloy in view of an improvement in magnetic properties. Examples of the Cr alloy include a CrW alloy, a CrMo alloy and a CrV alloy. The undercoat layer is not limited to a single layer, and it may have a structure of a plurality of layers formed by stacking identical or different layers. Further, for preventing the sticking of a magnetic head and the magnetic disk to each other (head sticking), a roughened control layer may be formed between the substrate and the magnetic layer or on the magnetic layer. Owing to the formation of the above roughened control layer, the surface roughness of the magnetic layer is properly adjusted, so that the sticking of the magnetic head and the magnetic disk to each other does not take place any longer. There can be therefore obtained a highly reliable magnetic disk.

As a protective layer, for example, a carbon protective layer is employed.

As a material for the lubricant layer, a variety of materials have been proposed. Generally, perfluoropolyether that is a liquid lubricant is diluted with a Freon type solvent, the thus-prepared solution is applied to the medium surface by a dipping, spin coating or spraying method and optionally the applied solution is heated to form the lubricant layer.

When the above head sticking is taken into account, the surface roughness of the magnetic disk is preferably a maximum surface roughness Rmax of 2 to 30 nm, more preferably an Rmax of 3 to 10 nm. When Rmax is less than 2 nm, undesirably, the magnetic disk surface is almost flat, so that a magnetic head or the magnetic disk may be damaged or head crash may be caused. Further, when Rmax exceeds 30 nm, undesirably, the glide height is too large and the recording density is decreased. In addition, the substrate surface may be textured.

### EXAMPLES

The present invention will be explained more in detail with reference to Examples hereinafter, while the present invention shall not be limited by these Examples.

Methods for measuring physical properties, etc., in Examples are as follows.

[Transmittance (%) at Wavelength of 600 nm]

A 1 mm thick sample having two precision-optically polished opposed surfaces was used as a sample for transmittance measurement, and the sample was measured for a transmittance (%) at a measurement wavelength of 600 nm with a HITACHI spectrometer U-3410 as a measuring apparatus.

[Specific Gravity (Density)]

A glass sample itself was used as a sample for specific gravity measurement. The sample was measured for a specific gravity with an electron specific gravity meter (MD-200S, supplied by Mirage Trading Corp.) using an Archimedean method. The specific gravity measurement accuracy at room temperature is ±0.001 (±0.001 g/cm³ in terms of a density).

[Young's Mdulus (GPa), Poisson's Ratio]

A sample having an end face area of 10×10 mm to 20×20 mm and a length of approximately 95 mm and having finished parallel surfaces was measured for a specific gravity (density) and measured for a sample length with a slide gauge before Young's modulus measurement, and the measurement values were used as measurement conditions. UVM-2 supplied by Ultrasonic Engineering Co., Ltd. was used as a measuring apparatus. When longitudinal waves (T11, T12) and transverse waves (TS1, TS2) were measured, “water” as a probe contact medium was applied to the probe and the end faces of the sample in the measurement of longitudinal waves and “Sonicoat SHN20 or SHN-B25” as a probe contact medium was applied thereto in the measurement of transverse waves. The same sample was repeatedly measured twice or more with regard to longitudinal waves and repeatedly measured five times or more with regard to transverse waves, and averages were calculated. By the above procedures, a Poisson's ratio was simultaneously obtained. The Young's modulus measurement accuracy was ±1 GPa, and the Poisson's ratio measurement accuracy was ±0.001.

[Crystal Species]

A powder obtained by pulverizing a crystallized glass was subjected to X-ray diffraction measurement using Kα ray of Cu (apparatus: X-ray diffraction apparatus MXP18A, supplied by MAC Science Co. Ltd., tube voltage: 50 kV, tube current: 300 mA, scanning angle 10-90°) . A precipitated crystal was identified on the basis of obtained X-ray diffraction peaks.

[Crystallinity]

A crystallized glass sample was measured for total scattering intensity, and on the basis of the result thereof, a crystallinity x(%) was determined on the basis of the following expression. As an X-ray diffraction apparatus, an X-ray diffraction apparatus MXP18A, supplied by MAC Science Co. Ltd. was used.
x=(1−(Ia/Ia100))×100
x=(Ic/Ic100)×100

Ia: Scattering intensity of amorphous portion of an unknown substance

Ic: Scattering intensity of crystalline portion of an unknown substance

Ia100: Scattering intensity of a 100% amorphous sample

Ic100: Scattering intensity of a 100% crystalline sample

The scattering intensity distribution of a 100% amorphous sample becomes a broad spectrum, and the scattering intensity distribution of a 100% crystalline sample becomes a spectrum having a narrow line width. The scattering intensity distribution of a crystallized glass becomes a form obtained by overlaying a spectrum having a narrow line width on the above broad spectrum. Ia is scattering intensity corresponding to a height of a largest portion of a broad spectrum from a base line that is a horizontal line connecting bottom portions of a spectrum. All the scattering intensities are values calculated using, as a base line, a horizontal line connecting bottom portions of a spectrum.

[Specific Modulus (MN·m/kg)

On the bass of the above Young's modulus and the above density at room temperature, a specific modulus was calculated according to the expression of specific modulus=Young's modulus/density.

[Average Linear Expansion Coefficient (×10⁻⁷/° C.)

Measured according to thermal mechanical analysis (abbreviated as TMA).

A glass sample was prepared by cutting, and the glass sample was ground to the form of a column having a size of φ50 mm×20 mm to obtain a measurement sample. As a measuring apparatus, TAS100 supplied by Rigaku Corporation was used. Under measurement conditions including a temperature elevation rate of 4° C./minute and a maximum temperature of 350° C., an average linear expansion coefficient at 100 to 300° C. was measured.

Further, for thermal properties other than the average linear thermal expansion coefficient, a test piece was prepared by cutting a crystallized glass sample, the test piece was ground to the form of a column having a size of φ5 mm×20 mm to obtain a measurement sample, and the measurement sample was measured with the above TAS100 supplied by Rigaku Corporation at a temperature elevation rate of 4° C./minute at a maximum temperature of 350° C.

[Average Surface Roughness (Ra), Maximum Surface Roughness (Rmax)]

Measured using an atomic force microscope (to be abbreviated as AFM).

A sample having a size of 30×25×1 mm was prepared from a crystallized glass sample, and two 30×25 mm surfaces were precision-optically polished to obtain a sample for measurement using AFM. The conditions for the measurement were of an AFM measurement range of 2×2 μm or 5×5 μm, a sample number of 256×256, a scan rate of 1 Hz, and the data processing conditions were of Planefit Auto order 3(X,Y) and Flatten Auto order 3. Integral gain, proportion gain and set point were adjusted in each measurement. As pretreatment for the measurement, polished samples were cleaned with pure water, isopropyl alcohol, etc., in a large-scale cleaner in a clean room.

[Size of Crystal Grains and Major Diameter/Minor Diameter Ratio of Crystal Grains]

A photograph of crystal grains in a crystallized glass was taken by magnification through a transmission electron microscope (TEM), and in the magnified image, the lengths of largest-length portions of crystal grains were taken as major diameters and the lengths of smallest length portions thereof were taken as minor diameters. The crystal grains were measured for sizes as described already. In the observation through the transmission electron microscope, thin-plate-like samples whose surfaces were precision-polished were used for good magnified images and each sample was observed perpendicular to the polished surface thereof through the transmission electron microscope.

### Example 1 (Preparation Example of Glass Shaped Material)

For obtaining a base material glass having a composition shown in Table 1 or 2, SiO₂, Al₂O₃, Al(OH)₃, MgO, Y₂O₃, TiO₂, ZrO₂, KNO₃, Sr(NO₃)₂, etc., as starting materials were weighed to prepare glass raw materials having a total amount of 250 to 300 g. Although not shown in Table 1 or 2, Sb₂O₃ was added to each glass in an amount of 0.03 mol % based on the above total amount of each glass. The above starting materials were fully mixed to prepare a batch and the prepared batch was placed in a melting vessel and melted with stirring at 1,550° C. in air for 4-5 hours.

As shown in FIG. 1, a molten glass in the melting vessel was continuously cast into an inlet of a mold 3 which had a straight through hole and which was made of a refractory material, from a pipe 1 connected to the melting vessel at a constant flow rate, to fill the above through hole with the molten glass 2 for shaping. In this case, the temperature of the molten glass flowing out of the pipe 1 was adjusted in a temperature range in which no devitrification took place. The mold 3 was arranged such that the central axis of the above through hole was in the vertical direction, and the pipe 1 and the mold 3 were position-adjusted such that the central axis of the through hole and the central axis of the pipe 1 were aligned on a straight line.

As shown in FIG. 1, a glass shaped material 4 was withdrawn while a circumferential surface 6 of the glass shaped material was held with a plurality of pairs of rollers 5 and while the rotation rate of the rollers 5 was controlled. The rotation rate of the rollers 5 was controlled so as to render constant the height of a liquid level of the molten glass in the through hole of the mold by monitoring the liquid level with a liquid level sensor 8 according to an optical method and outputting a withdrawal rate adjusting signal to the rollers 5 from a controller 9 on the basis of a monitor signal.

As shown in FIG. 1, the glass shaped material withdrawn from a withdrawal outlet was allowed to pass through a shaping furnace 7 which was disposed below the mold 3 and which was temperature-adjusted to a temperature range around the glass transition temperature of the base material glass, so that the temperature difference between the circumferential surface and inner central portion of the glass shaped material was adjusted, whereby the breakage of the glass shaped material was prevented.

As shown in FIG. 3, a marking line is formed on a predetermined position of the circumferential surface of the glass shaped material that had passed through the shaping furnace 7, by scribing before the glass shaped material was completely cooled. With placing a fulcrum on a position opposed to the scribed position, that portion of the glass shaped material which was lower than the above scribed position was pressed in the horizontal direction, thereby to apply a torque to the glass shaped material with the fulcrum being as a center, so that the glass shaped material was split (see FIG. 4). In this case, there may be employed a constitution in which a water-cooled jacket is pressed on the scribed position to cause a crack toward the fulcrum from the scribed position and a smaller torque is applied for the splitting.

A columnar glass shaped material separated by the above splitting from the glass shaped material under withdrawal was annealed to remove a strain. The precipitation of a crystal and the occurrence of striae were not observed in the obtained glass shaped material.

Then, the glass shaped material obtained by the above splitting was centerless ground to complete a columnar glass shaped material having an outer diameter of 28.8 mm, an outer diameter tolerance of ±0.05 mm or smaller, a length of 180 mm and a straightness of 0.005 mm.

### Example 2 (Preparation Example of Crystallized Glass Material)

The above centerless ground glass shaped material was placed on rollers which were made of silicon nitride and were arranged side by side in parallel in a thermal treatment furnace such that the axes of the rollers were in parallel with the central axis of the glass shaped material, and the glass shaped material was heat-treated while the rollers were rotated. The rotation rate of the rollers was set such that the glass shaped material rotated at a rate of 1 turn/minute.

In the heat treatment, the glass shaped material was temperature-increased to a primary thermal treatment temperature (crystal nucleation thermal treatment temperature) shown in Table 1 or 2 at a temperature elevation rate (first temperature elevation rate) of 300° C./hour, and maintained at the above temperature for approximately 4 hours to carry out primary heat treatment. Immediately after the primary heat treatment, the above-treated glass shaped material was temperature-increased from the primary thermal treatment temperature to a secondary thermal treatment temperature (crystallization thermal treatment temperature) shown in Table 1 or 2 at a temperature elevation rate (second temperature elevation rate) of 240° C./hour, maintained at the secondary thermal treatment temperature for approximately 4 hours and then cooled to room temperature in the furnace to give a crystallized glass material. A crystallized glass constituting the thus-obtained crystallized glass material was measured for a Young's modulus, specific gravity, etc., and Table 1 or 2 shows the results together with the composition of the base material glass thereof. Crystallized glasses obtained in the above manner had a crystallinity of 20 to 70% by volume and enstatite and a solid solution thereof as crystal grains in each crystallized glass had a Mohs hardness of 5.5.

Further, the compositions of the crystallized glasses were analyzed to show that the compositional difference between the base material glass and the corresponding crystallized glass in each of them was ±0.1 mol % or smaller. It can be therefore considered that the compositions of the base material glasses shown in Tables 1 and 2 are substantially the same as the compositions of the corresponding crystallized glasses.

TABLE 1

| | | No | | | | |
|---|---|---|---|---|---|---|
| | | 1 | 2 | 3 | 4 | 5 |
| Glass Composition | SiO₂ | 48.0 | 47.0 | 46.0 | 49.0 | 46.0 |
| (mol %) | Al₂O₃ | 11.0 | 10.5 | 10.5 | 10.5 | 10.5 |
| | MgO | 30.0 | 30.0 | 31.0 | 29.5 | 30.5 |
| | K₂O | 0.0 | 0.0 | 0.0 | 0.0 | 0.5 |
| | SrO | 0.0 | 0.0 | 0.0 | 0.0 | 0.0 |
| | Y₂O₃ | 1.0 | 0.5 | 0.5 | 1.0 | 0.5 |
| | ZrO₂ | 0.0 | 2.0 | 2.0 | 0.0 | 2.0 |
| | TiO₂ | 10.0 | 10.0 | 10.0 | 10.0 | 10.0 |
| | SiO₂/MgO | 1.60 | 1.57 | 1.48 | 1.66 | 1.51 |
| | SiO₂ + Al₂O₃ + MgO + TiO₂ | 99.0 | 97.5 | 97.5 | 99.0 | 97.0 |
| Heat treatment conditions - | Glass transition | 732 | 735 | 732 | 732 | 726 |
| Properties of | temperature (° C.) | | | | | |
| crystallized glass | Crystal nucleation thermal | 760 | 770 | 770 | 760 | 756 |
| | treatment temperature (° C.) | | | | | |
| | Crystal nucleation thermal | 4 | 4 | 4 | 4 | 4 |
| | treatment (hour) | | | | | |
| | 1st temperature elevation | 300 | 300 | 300 | 300 | 300 |
| | rate (° C./hour) | | | | | |
| | Crystallization thermal | 1000 | 1000 | 1000 | 1000 | 1000 |
| | treatment temperature (° C.) | | | | | |
| | Crystallization thermal | 4 | 4 | 4 | 4 | 4 |
| | treatment time (hour) | | | | | |
| | 2nd temperature elevation | 240 | 240 | 240 | 240 | 240 |
| | rate (° C./hour) | | | | | |
| | Transmittance at wavelength | 75 | 73 | 79 | 76 | 82 |
| | of 600 nm (%) | | | | | |
| | Specific gravity | 3.09 | 3.14 | 3.16 | 3.07 | 3.13 |
| | Young's modulus (GPa) | 149 | 150 | 153 | 149 | 149 |
| | Poisson's ratio | 0.23 | 0.23 | 0.23 | 0.23 | 0.23 |
| | Crystal species having the | Enst.*1 | Enst.*1 | Enst.*1 | Enst.*1 | Enst.*1 |
| | largest content by volume | | | | | |
| | Other crystal species | Titan*2 | Titan*2 | Titan*2 | Titan*2 | Titan*2 |
| | Specific modulus (MNm/kg) | 48.1 | 47.9 | 48.5 | 48.6 | 47.7 |
| | Average linear expansion | 72 | 72 | 74 | 77 | 78 |
| | coefficient (×10⁻⁷/° C.) | | | | | |
| | Ra (nm) | 0.3 | 0.3 | 0.25 | 0.3 | 0.2 |
| | Size of crystal grains (nm) | 30-40 | 30-40 | 20-30 | 40-50 | 20-30 |
| | Major diameter/minor | 5-7 | 5-7 | 5-7 | 5-8 | 5-8 |
| | diameter of crystal grains | | | | | |
| | Result of operation test | A*3 | A*3 | A*3 | A*3 | A*3 |
| | with recording apparatus | | | | | |

Notes:
Enst.*1 = Enstatite and enstatite solid solution,
Ttian*2 = Titanate,
A*3 = Excellent

TABLE 2

| | | No | | | | |
|---|---|---|---|---|---|---|
| | | 6 | 7 | 8 | 9 | 10 |
| Glass Composition | SiO₂ | 46.0 | 46.0 | 46.0 | 46.0 | 46.0 |
| (mol %) | Al₂O₃ | 10.5 | 10.5 | 10.5 | 10.5 | 10.5 |
| | MgO | 30.0 | 30.0 | 31.0 | 30.0 | 31.0 |
| | K₂O | 0.0 | 0.0 | 0.0 | 0.5 | 0.5 |
| | SrO | 1.0 | 1.5 | 1.0 | 0.5 | 0.0 |
| | Y₂O₃ | 0.5 | 0.0 | 0.5 | 0.5 | 0.5 |
| | ZrO₂ | 2.0 | 2.0 | 2.0 | 2.0 | 2.0 |
| | TiO₂ | 10.0 | 10.0 | 9.0 | 10.0 | 9.5 |
| | SiO₂/MgO | 1.53 | 1.53 | 1.48 | 1.53 | 1.48 |
| | SiO₂ + Al₂O₃ + MgO + TiO₂ | 96.5 | 96.5 | 96.5 | 96.5 | 97.0 |
| Heat treatment conditions - | Glass transition | 728 | 726 | 725 | 727 | 734 |
| Properties of | temperature (° C.) | | | | | |
| crystallized glass | Crystal nucleation thermal | 758 | 756 | 755 | 757 | 760 |
| | treatment temperature (° C.) | | | | | |
| | Crystal nucleation thermal | 4 | 4 | 4 | 4 | 4 |
| | treatment (hour) | | | | | |
| | 1st temperature elevation | 300 | 300 | 300 | 300 | 300 |
| | rate (° C./hour) | | | | | |
| | Crystallization thermal | 1000 | 1000 | 1000 | 1000 | 1000 |
| | treatment temperature (° C.) | | | | | |
| | Crystallization thermal | 4 | 4 | 4 | 4 | 4 |
| | treatment time (hour) | | | | | |
| | 2nd temperature elevation | 240 | 240 | 240 | 240 | 240 |
| | rate (° C./hour) | | | | | |
| | Transmittance at wavelength | 70 | 67 | 80 | 80 | 78 |
| | of 600 nm (%) | | | | | |
| | Specific gravity | 3.17 | 3.18 | 3.12 | 3.15 | 3.14 |
| | Young's modulus (GPa) | 152 | 152 | 147 | 148 | 150 |
| | Poisson's ratio | 0.23 | 0.23 | 0.23 | 0.23 | 0.23 |
| | Crystal species having the | Enst.*1 | Enst.*1 | Enst.*1 | Enst.*1 | Enst.*1 |
| | largest content by volume | | | | | |
| | Other crystal species | Titan*2 | Titan*2 | Titan*2 | Titan*2 | Titan*2 |
| | Specific modulus (MNm/kg) | 47.9 | 47.9 | 47.9 | 47.0 | 47.6 |
| | Average linear expansion | 75 | 75 | 79 | 78 | 75 |
| | coefficient (×10⁻⁷/° C.) | | | | | |
| | Ra (nm) | 0.3 | 0.3 | 0.3 | 0.25 | 0.2 |
| | Size of crystal grains (nm) | 30-50 | 30-50 | 20-30 | 20-30 | 20-30 |
| | Major diameter/minor | 5-8 | 5-8 | 5-8 | 5-8 | 5-8 |
| | diameter of crystal grains | | | | | |
| | Result of operation test | A*3 | A*3 | A*3 | A*3 | A*3 |
| | with recording apparatus | | | | | |

Notes:
Enst.*1 = Enstatite and enstatite solid solution,
Ttian*2 = Titanate,
A*3 = Excellent

[Additional Notes to Tables 1 and 2]

(1) In Tables 1 and 2, 1st temperature elevation rate refers to a temperature elevation rate at which a glass shaped material is temperature-elevated up to a crystal nucleation thermal treatment temperature, and 2nd temperature elevation rate refers to a temperature elevation rate at which a glass shaped material is temperature-increased from the crystal nucleation temperature to a crystallization thermal treatment temperature.

(2) Enst*1 stands for enstatite and an enstatite solid solution.

(3) Glass transition temperature in Tables 1 and 2 refer to the glass transition temperature of a crystallized glass.

As is clear from the results shown in Tables 1 and 2, the major diameter/minor diameter ratio of crystal grains of each crystallized glass is 3 or more. Further, the crystallized glasses have high strength properties such as a Young's modulus (140 GPa or more) and a specific modulus (in the range of 40-60 MN·m/kg). It is therefore seen that when these glasses are used as materials for substrates for information recording media such as a magnetic recording disk substrate, the substrates are free from distortion or wobbling, so that these glasses are compatible with a further decrease in the thickness of the substrates. Further, when the glasses Nos. 1, 3 and 5 before the thermal treatment were measured for liquidus temperatures, they had liquidus temperatures of 1,300° C., 1,290° C. and 1,270° C., and these values satisfy the liquidus temperature (e.g., 1,350° C. or lower) that a glass is required to have from the viewpoint of melting and shaping.

The above rod-like crystallized glass materials were centerless ground to obtain 25 columnar crystallized glass materials having an outer diameter of 28.8 mm, an outer diameter tolerance of ±0.050 mm or smaller, a length of 180 mm and a straightness of 0.005 mm.

### Example 3 (Preparation Example of Magnetic Disk Substrate Blank, Magnetic Disk Substrate and Magnetic Disk)

As shown in FIG. 8, the columnar crystallized glass materials obtained in Example 2 were stacked in a quantity of 5 per layer such that they were aligned in the longitudinal direction and that the central axes of them formed the lattice of squares when they were viewed in the central axis direction of them, to give a stack structure. The crystallized glass materials for constituting the stack structure were fixed on a work-fixing bed of a commercially available multi-wire saw with an epoxy adhesive in a manner in which any one of them was in intimate contact with neighboring ones.

The above stack structure was brought near to a lower portion of the wire saw in operation and the side thereof was pressed to the wire saw to slice it at a constant speed. The slicing was carried out in a slurry and the wires were set at intervals of 0.5 mm.

Works obtained by the slicing were placed in an organic solvent to dissolve the adhesive and then ultrasonically cleaned to give about 5,400 disk-like crystallized glasses having the same diameters and thicknesses as magnetic disk substrate blanks. Both main surfaces of each of these disk-like crystallized glasses were precision-polished such that the surfaces had a surface average roughness Ra (JIS B0601) of 0.4 nm and a maximum surface roughness Rmax of 4 nm. And, central holes were made in each of them and circumferences of each of them were polished, to give magnetic disk substrates formed of crystallized glasses. Each magnetic disk substrate had an outer diameter of 28.70 mm, a central hole diameter of 7 mm and a thickness of 0.381 mm.

The ultrasonic cleaning step was carried out with regard to the substrates as required. However, there was no case where crystal grains fell off the substrate surface formed of the crystallized glass containing the enstatite crystal phase by ultrasonic wave application. In this step, the ultrasonic wave had a frequency of 20 kHz.

On each of the thus-obtained magnetic disks, an undercoat layer, a magnetic layer (magnetic recording layer), a protective layer and a lubricant layer were consecutively formed. These layers were specifically as follows. The undercoat layer was a 25 nm thick CrV thin film having a compositional ratio of Cr: 80 at % and V: 20 at %. The magnetic layer was an approximately 15 nm thick CrCrPtB thin film having a compositional ratio of Co: 60 at %, Cr: 20 at %, Pt: 14 at % and B: 6 at %. The protective layer was a 6 nm thick hydrogenated carbon thin film. The lubricant layer was formed from perfluoropolyether.

The above magnetic disks were produced as follows. First, the magnetic disk substrate was set on a substrate holder and introduced into a feeding chamber of a static opposed-type apparatus and then an under coat layer, a magnetic layer and a protective layer were consecutively formed by DC magnetron sputtering using Ar-containing gas. In the formation of the protective layer, an Ar+H₂ gas prepared by mixing Ar gas with 20% of hydrogen was used. Then, a perfluoropolyether was applied on the hydrogenated carbon protective layer by a dipping method to form a lubricant layer having a thickness of 1.0 nm. In this manner, magnetic disks were obtained.

When the above magnetic recording disks were respectively incorporated into a recording device and tested for their operations, they showed excellent results as shown in Tables 1 and 2.

Magnetic disk substrates and magnetic disks were produced highly productively in the above manner.

### INDUSTRIAL UTILITY

According to the present invention, there can be stably produced a glass shaped material as a base material for a crystallized glass material, there can be obtained columnar crystallized glass materials that can be highly accurately sliced simultaneously when a plurality of them are stacked such that they are aligned in the longitudinal direction, and there can be suitably produced a magnetic disk substrate blank, a magnetic disk substrate and a magnetic disk from the above glass shaped material or the above crystallized glass material.

1. A process for the production of a glass shaped material, which comprises
casting a molten glass into a through hole of a mold, the through hole having a straight central axis, said central axis being vertical or slanted relative to a horizontal, and
shaping the molten glass into a rod-like glass shaped material as a base material for a crystallized glass material.

2. The process for the production of a glass shaped material as recited in claim 1, wherein said glass comprises TiO₂, SiO₂ and MgO and has an SiO₂/MgO molar ratio of from 0.8 to 6.0.

3. The process for the production of a glass shaped material as recited in claim 1, wherein said glass comprises, by mol %, 35 to 65% of SiO₂, over 5% to 20% of Al₂O₃, 10 to 40% of MgO and 5 to 15% of TiO₂, the total content of SiO₂, Al₂O₃, MgO and TiO₂ is 92% or more and the SiO₂/MgO molar ratio is from 0.8 to 6.0.

4. The process for the production of a glass shaped material as recited in claim 1, wherein a circumferential surface of the glass shaped material is further machined to obtain a columnar form.

5. A crystallized glass material that is obtained by heat-treatment of a glass shaped material and has a columnar form having a length of L (mm), an outer diameter tolerance of ±0.2 mm or smaller and a straightness of 5×10⁻⁵×L (mm) or less.

6. The crystallized glass material of claim 5, which contains enstatite and/or an enstatite solid solution as a crystal phase.

7. The crystallized glass material of claim 5, which has a length L of 100 mm or more and an outer diameter of 16 to 70 mm.

8. The crystallized glass material of claim 5, whose circumferential surface has an average roughness Ra of 0.3 μm or less.

9. The crystallized glass of claim 5, which is a base material for a magnetic disk substrate.

10. A process for the production of a crystallized glass material, which comprises thermally treating a glass shaped material produced by the process of claim 1 to obtain a crystallized glass material having a crystal phase precipitated in the entirety of a use region.

11. The process for the production of a crystallized glass material as recited in claim 10, wherein the glass shaped material having a columnar form is heated for crystallization while the glass shaped material is rotated in the circumferential direction about the central axis of the columnar form.

12. The process for the production of a crystallized glass material as recited in claim 11, wherein the crystallized glass material obtained is a crystallized glass material that is obtained by the heat-treatment of the glass shaped material and has a columnar form having a length L (mm), an outer diameter tolerance of ±0.2 mm or smaller and a straightness of 5×10⁻⁵×L (mm) or less.

13. A process for the production of a magnetic disk substrate blank, which comprises slicing a glass shaped material produced by the process of claim 1 perpendicular to the longitudinal direction of said glass shaped material and then thermally treating a sliced glass piece to obtain a magnetic disk substrate blank having a crystal phase precipitated in the entirety of a use region.

14. A process for the production of a magnetic disk substrate blank, which comprises slicing the crystallized glass material of claim 5 perpendicular to the longitudinal direction of the crystallized glass material.

15. A process for the production of a magnetic disk substrate blank, which comprises slicing the crystallized glass material produced by the process of claim 10 perpendicular to the longitudinal direction of the crystallized glass material.

16. A process for the production of a magnetic disk substrate, which comprises polishing a main surface of a magnetic disk substrate blank produced by the process of claim 13.

17. A process for the production of a magnetic disk, which comprises forming a magnetic recording layer on a magnetic disk substrate produced by the process of claim 16.
